(19) United States
(12) Patent Application Publication
(10) Pub. No.: US 2011/0244859 A1
(43) Pub. Date: Oct. 6, 2011

(54) COMMUNICATION CONTROL APPARATUS, COMMUNICATION CONTROL METHOD, PROGRAM, TERMINAL EQUIPMENT AND WIRELESS COMMUNICATION SYSTEM

(75) Inventor: Shinichiro Tsuda, Kanagawa (JP)

(73) Assignee: Sony Corporation, Tokyo (JP)

(21) Appl. No.: 13/069,103

(22) Filed: Mar. 22, 2011

(30) Foreign Application Priority Data
Mar. 31, 2010 (JP) 2010-082336

(51) Int. Cl. H04W 36/00

(52) U.S. Cl. 455/436

(57) ABSTRACT

There is provided a communication control apparatus to control handover with terminal equipment including a position information acquisition unit to acquire position information containing a cell ID specifying a cell to which the terminal equipment is connected, a storage unit to store a series of the position information acquired by the position information acquisition unit as position information history, a determination unit to determine whether the terminal equipment should have been connected to each cell specified by each cell ID contained in the position information history on a movement route of the terminal equipment, and a data generation unit to generate recommended handover order data indicating connection order of cells to be recommended for the terminal equipment by removing a cell ID specifying a cell determined to which the terminal equipment should not have been connected by the determination unit from the position information history.

### BACKGROUND OF THE INVENTION

1. Field of the Invention

The present invention relates to a communication control apparatus, a communication control method, a program, terminal equipment and a wireless communication system.

2. Description of the Related Art

Currently, cellular communication with cellular phones and the like compatible with a communication method called the third generation (3G) has been widely performed. In such cellular communication, in the case that terminal equipment such as a cellular phone moves across a boundary of a cell, it is desired to perform handover to switch cells to which the terminal equipment is connected. Although handover is necessary to maintain a communication state for the terminal equipment, handover may be load for a system in the meantime.

Accordingly, it is desired to minimalize a system load while maintaining a communication state of terminal equipment by optimizing switching order of cells to which the terminal equipment is connected with handover. Technologies to optimize the switching order of cells to which terminal equipment is connected by forecasting a movement destination of the terminal equipment are disclosed in Japanese Patent Application Laid-open (JP-A) No. 2000-217138 and Japanese Patent No. 4126134.

### SUMMARY OF THE INVENTION

Data quantity transmitted and received by terminal equipment is remarkably increased with recent spread of provision of music and video to cellular phones. Further, opportunities to perform data communication continuously while terminal equipment is moving at high speed have been increasing. Switching order of cells to be connected with handover is further important for such terminal equipment. For example, a cell having short distance or time of connection with terminal equipment causes only a load to a system with handover performed by the terminal equipment while providing little service to the terminal equipment. Further, for example, a congested cell may not provide a sufficient communication rate to terminal equipment. In such cases, in order to optimize switching order of cells to which terminal equipment is connected, it is desired to remove cells as described above to which the terminal equipment should not be connected from access points. However, it is difficult to sufficiently optimize switching order of cells to be connected in the related art.

Further, practical realization of a cellular communication specification of the next generation such as Long Term Evolution (LTE) and LTE-Advanced (LTE-V) is scheduled in near future. With these specifications, there is a tendency that cells are smaller with higher communication rates than those for 3G in the related art. Accordingly, cellular communication in near future will be performed in a heterogeneous environment in which cells having different sizes and communication rates are mixed. In such an environment, in order to optimize switching order of cells to which terminal equipment is connected with handover, it is desired to consider conditions such as sizes and communication rates of respective cells in addition to a movement destination of the terminal equipment. However, in the related art, it is difficult to sufficiently optimize switching order of cells to be connected.

In light of the foregoing, it is desirable to provide a novel and improved communication control apparatus, a communication control method, a program, terminal equipment, and a wireless communication system capable of optimizing switching order of cells to which terminal equipment is connected with handover.

According to an embodiment of the present invention, there is provided a communication control apparatus to control handover with terminal equipment including a position information acquisition unit to acquire position information containing a position of the terminal equipment and a cell ID specifying a cell to which the terminal equipment is connected at the position, a storage unit to store a series of the position information acquired by the position information acquisition unit as position information history, a determination unit to determine whether or not the terminal equipment should have been connected to each cell specified by each cell ID contained in the position information history on a movement route of the terminal equipment corresponding to the position information history stored in the storage unit, and a data generation unit to generate recommended handover order data indicating connection order of cells to be recommended for the terminal equipment by removing a cell ID specifying a cell determined to which the terminal equipment should not have been connected by the determination unit from the position information history.

With the above configuration, recommended handover order data may be obtained based on position information history of terminal equipment, and then, switching order of cells to which terminal equipment is connected with handover may be optimized by utilizing the recommended handover order data.

The storage unit may further store cell information to calculate an estimation rate at an arbitrary position of each cell constituting a wireless communication system. The determination unit may determine a cell to which the terminal equipment should not have been connected by evaluating the estimation rate on the movement route of each cell specified by each cell ID contained in the position information history by utilizing the cell information stored in the storage unit.

The determination unit may calculate the estimation rates of two cells to which the terminal equipment has been connected respectively right before and right after being connected to a target cell at least at one position where the terminal equipment has been connected to the target cell specified by one of cell IDs contained in the position information history. The determination unit may determine that the terminal equipment should not have been connected to the target cell when at least one of the estimation rates of the two cells exceeds a predetermined threshold value.

The determination unit may set a cell having time or distance of connection with the terminal equipment satisfy a predetermined condition as a candidate cell among respective cells specified by respective cell IDs contained in the position information history. The determination unit may determine whether or not the terminal equipment should have been connected thereto only for the candidate cell.

The determination unit may set a cell having at least one of time and distance of connection with the terminal equipment fall below a predetermined threshold value as the candidate cell among respective cells specified by respective IDs contained in the position information history.

The position information acquisition unit may further acquire information indicating a congestion factor of each cell specified by each cell ID contained in the position information history. The determination unit may set a cell having the congestion factor exceed a predetermined level as a candidate cell among respective cells specified by respective cell IDs contained in the position information history. The determination unit may determine whether or not the terminal equipment should have been connected thereto only for the candidate cell.

The communication control apparatus may further include a forecast unit to forecast a movement destination of a moving terminal equipment by utilizing a position provided from the moving terminal equipment and the position information history, and a data provision unit to provide the recommended handover order data to be selected based on the movement destination among one or more of the recommended handover order data to the moving terminal equipment.

The position information history utilized by the forecast unit may include the position information history of terminal equipment other than the moving terminal equipment.

According to another embodiment of the present invention, there is provided a communication control method to control handover with terminal equipment, including the steps of acquiring position information containing a position of the terminal equipment and a cell ID specifying a cell to which the terminal equipment is connected at the position, storing a series of the position information in a storage device as position information history, determining whether or not the terminal equipment should have been connected to each cell specified by each cell ID contained in the position information history on a movement route of the terminal equipment corresponding to the position information history, and generating recommended handover order data indicating connection order of cells to be recommended for the terminal equipment by removing a cell ID specifying a cell determined to which the terminal equipment should not have been connected from the position information history.

According to yet another embodiment of the present invention, there is provided a program for causing a computer to function as a mean to acquire position information containing a position of terminal equipment and a cell ID specifying a cell to which the terminal equipment is connected at the position, a mean to store a series of the position information as position information history, a mean to determine whether or not the terminal equipment should have been connected to each cell specified by each cell ID contained in the position information history on a movement route of the terminal equipment corresponding to the position information history, and a mean to generate recommended handover order data indicating connection order of cells to be recommended for the terminal equipment by removing a cell ID specifying a cell determined to which the terminal equipment should not have been connected from the position information history.

According to further yet another embodiment of the present invention, there is provided a terminal equipment, including a wireless communication unit to perform wireless communication, a position information provision unit to provide position information containing a position of the terminal equipment and a cell ID specifying a cell to which the terminal equipment is connected at the position to a communication control apparatus, a data acquisition unit to acquire recommended handover order data from the communication control apparatus indicating connection order of cells to be recommended for the terminal equipment generated by removing a cell ID satisfying a predetermined condition from a series of the position information, and a control unit to control wireless communication with the wireless communication unit so that a series of handover to be performed by the terminal equipment is performed in accordance with the connection order.

The control unit may vary a measurement value of each cell contained in a measurement report to be transmitted to a base station in accordance with whether or not a cell ID specifying the cell is contained in the recommended handover order data.

The control unit may add a negative offset to a measurement value of the cell specified by the cell ID which is not contained in the recommended handover order data among measurement values of respective cells contained in the measurement report.

According to further yet another embodiment of the present invention, there is provided a wireless communication system including a communication control apparatus to control handover with terminal equipment, and the terminal equipment. The communication control apparatus includes a position information acquisition unit to acquire position information containing a position of the terminal equipment and a cell ID specifying a cell to which the terminal equipment is connected at the position, a storage unit to store a series of the position information acquired by the position information acquisition unit as position information history, a determination unit to determine whether or not the terminal equipment should have been connected to each cell specified by each cell ID contained in the position information history on a movement route of the terminal equipment corresponding to the position information history stored in the storage unit, and a data generation unit to generate recommended handover order data indicating connection order of cells to be recommended for the terminal equipment by removing a cell ID specifying a cell determined to which the terminal equipment should not have been connected by the determination unit from the position information history. The terminal equipment includes, a wireless communication unit to perform wireless communication, a position information provision unit to provide position information containing a position of the terminal equipment and a cell ID specifying a cell to which the terminal equipment is connected at the position to a communication control apparatus, a data acquisition unit to acquire recommended handover order data from the communication control apparatus indicating connection order of cells to be recommended for the terminal equipment generated by removing a cell ID satisfying a predetermined condition from a series of the position information, and a control unit to control wireless communication with the wireless communication unit so that a series of handover to be performed by the terminal equipment is performed in accordance with the connection order.

As described above, according to the present invention, it is possible to optimize switching order of cells to which terminal equipment is connected with handover.

### BRIEF DESCRIPTION OF THE DRAWINGS

FIG. 1 is a sequence diagram describing an example of general handover procedure;

FIG. 2 is an explanatory view of an example of a cell to which terminal equipment should not be connected;

FIG. 3 is an explanatory view of an example of a cell to which terminal equipment should not be connected;

FIG. 4 is a schematic view illustrating a general outline of a wireless communication system according to an embodiment;

FIG. 5 is a block diagram illustrating an example of the configuration of a communication control apparatus according to an embodiment;

FIG. 6 is an explanatory view of a data image of position information history stored in a storage unit of the communication control apparatus according to an embodiment;

FIG. 7 is an explanatory view of a data image of cell information stored in the storage unit of the communication control apparatus according to an embodiment;

FIG. 8 is an explanatory view of a data image of recommended handover order data stored in the storage unit of the communication control apparatus according to an embodiment;

FIG. 9 is an explanatory view of a data image of recommended handover order data related information stored in the storage unit of the communication control apparatus according to an embodiment;

FIG. 10 is an explanatory view of a route pattern ID;

FIG. 11 is an explanatory view of an example of a process to forecast a movement destination of terminal equipment to be performed by a forecast unit of the communication control apparatus according to an embodiment;

FIG. 12 is a flowchart describing a general outline of a process to be performed by the communication control apparatus according to an embodiment;

FIG. 13 is a flowchart describing a determination process to be performed by a determination unit of the communication control apparatus according to an embodiment;

FIG. 14 is a flowchart describing a determination process for each record to be performed by the determination unit of the communication control apparatus according to an embodiment;

FIG. 15 is an explanatory view of an estimation rate calculation process of two cells before and after an evaluation position and an update process of the evaluation position to be performed by the determination unit of the communication control apparatus according to an embodiment;

FIG. 16 is a flowchart describing a general outline of processes to be performed by a forecast unit and a data provision unit of the communication control unit according to an embodiment;

FIG. 17 is a block diagram illustrating an example of the configuration of a base station according to an embodiment;

FIG. 18 is a block diagram illustrating an example of the configuration of terminal equipment according to an embodiment;

FIG. 19 is a flowchart describing a process to vary a measurement value of a measurement report to be performed by a control unit of the terminal equipment according to an embodiment;

FIG. 20 is a flowchart describing a process to be performed by the determination unit of the communication control unit according to a first modified example; and

FIG. 21 is a flowchart describing a process to be performed by the determination unit of the communication control unit according to a second modified example.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Further, in the present specification, a symbol having an alphabet given to a numeral thereafter is utilized when structural elements having substantially the same function and structure as the structural element indicated by a symbol without having an alphabet are necessary to be discriminated from one another for a reason of existing in plural or being indicated in temporal sequence and the like.

Hereinafter, embodiments of the present invention will be described in the following order.

1. Description of related art

1-1. Handover procedure

1-2. Examples of cell to which terminal equipment should not be connected

### 2. Embodiment

2-1. Configuration of wireless communication system

2-2. Configuration of communication control apparatus

2-3. Configuration of base station

2-4. Configuration of terminal equipment

2-5. Modified examples

2-6. Summary

### 1. Description of Related Art

### 1-1. Handover Procedure

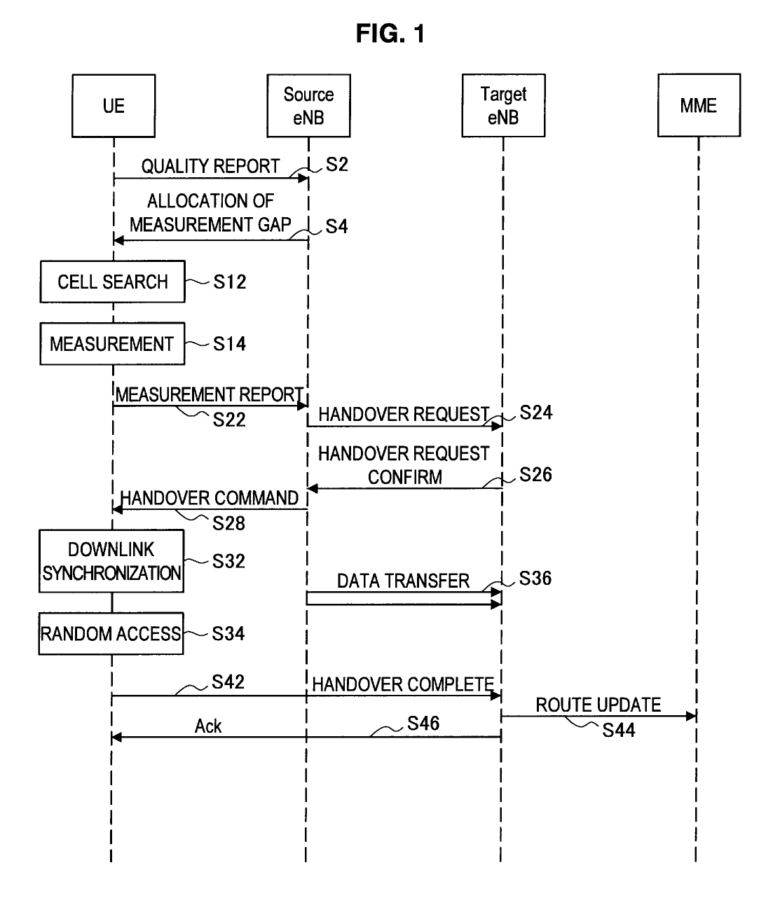

First, the related art will be described with reference to FIGS. 1 to 3. FIG. 1 illustrates flow of handover procedure being compliant with Long Term Evolution (LTE) as a general example of the handover procedure. Here, terminal equipment for user (UE), a source base station (Source eNB), a target base station (Target eNB) and a mobility management entity (MME) are involved in the handover procedure.

At a stage prior to the handover, the terminal equipment firstly reports channel quality of a communication channel between the terminal equipment and the source base station to the source base station (step S2). The report of the channel quality may be performed periodically or may be performed as being triggered when the channel quality falls below a reference value which is previously determined. The terminal equipment may measure the channel quality of the communication channel with the source base station by receiving a reference signal contained in a downlink channel from the source base station.

Next, the source base station determines whether or not measurement is necessary based on the quality report received from the terminal equipment. When the measurement is necessary, a measurement gap is allocated to the terminal equipment (step S4).

The terminal equipment having the measurement gap allocated searches a downlink channel from a base station of a neighboring cell, that is, performs cell search (step S12). Here, the terminal equipment may recognize the base station of the neighboring cell to be searched in accordance with a list previously provided from the source base station.

Next, when being synchronized with the downlink channel, the terminal equipment performs measurement by utilizing the reference signal contained in the downlink channel (step S14), and then, transmits a measurement report containing channel quality of the base station of the neighboring cell to the source base station as a result of the measurement (step S22).

The source base station having the measurement report received determines whether or not handover is to be performed based on content of the measurement report. For example, in the case that channel quality of another neighboring base station is higher than the channel quality of the source base station by a predetermined threshold value or more, it may be determined that handover is necessary. In this case, the source base station determines to conduct the handover procedure having the other base station as the target base station, and then, transmits Handover Request to the target base station (step S24).

The target base station having the Handover Request received determines whether or not the terminal equipment may be accepted in accordance with availability of own providing communication service. Then, when the terminal equipment may be accepted, the target base station transmits Handover Request Confirm to the source base station (step S26).

The source base station having the Handover Request Confirm received transmits Handover Command to the terminal equipment (step S28). Accordingly, the terminal equipment gets synchronized with the downlink channel of the target base station (step S32). Next, the terminal equipment performs random access to the target base station using a random access channel arranged at a predetermined time slot (step S34). During that time, the source base station transfers arriving data addressed to the terminal equipment to the target base station (step S36). Then, when succeeding in the random access, the terminal equipment transmits Handover Complete to the target base station (step S42).

The target base station having Handover Complete received requests to the MME to update a route for the terminal equipment (step S44). Since the route for user data is updated by the MME, the terminal equipment becomes capable of communicating with other equipment via a new base station, that is, the target base station. Then, the target base station transmits Acknowledgement to the terminal equipment (step S46). Thus, a series of handover procedure is completed.

### 1-2. Examples of Cell to which Terminal Equipment should not be Connected

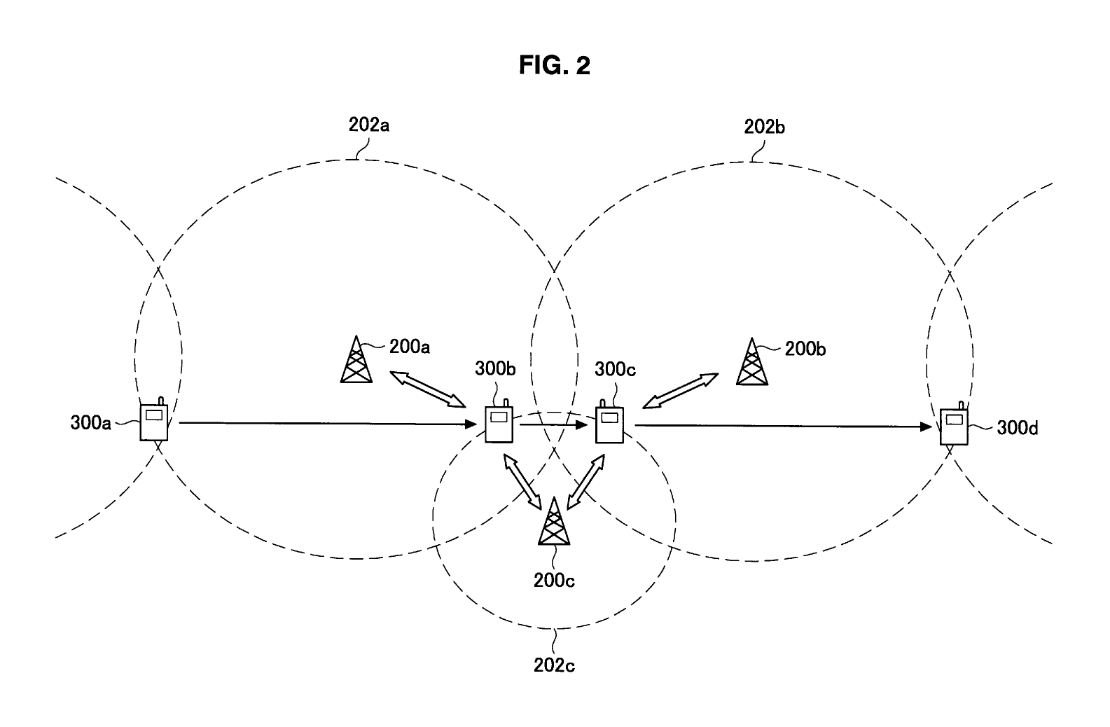

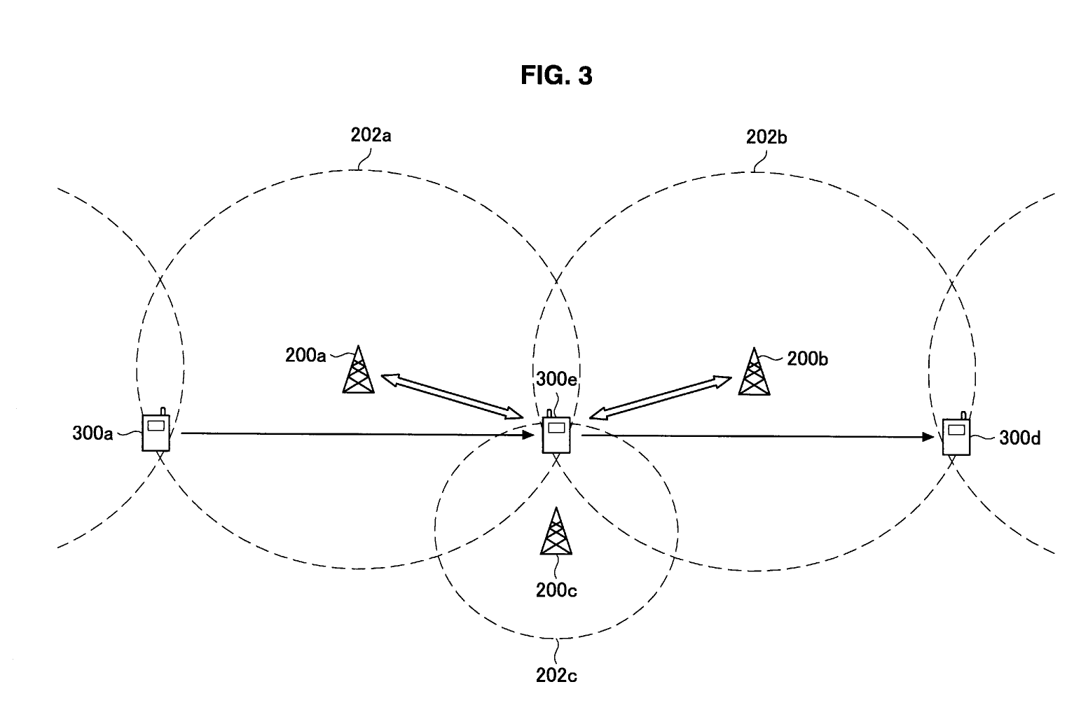

FIGS. 2 and 3 are explanatory views for describing examples of cells to which terminal equipment 300 should not be connected. The terminal equipment 300 located at each position on the move is indicated respectively as terminal equipments 300a to 300e.

Here, the movement route of the terminal equipment 300 extends over several cells 202 to which wireless communication service is provided respectively by several base stations 200. In the examples of FIGS. 2 and 3, the movement route of the terminal equipment 300 extends over a cell 202a of a base station 200a, a cell 202b of a base station 200b, and a cell 202c of a base station 200c.

FIG. 2 illustrates the terminal equipment 300a as starting movement, the terminal equipment 300b as performing the first handover, the terminal equipment 300c as performing the second handover, and the terminal equipment 300d as ending movement. The terminal equipment 300a starts movement in a state of being connected to the cell 202a.

The terminal equipment 300b performs handover from the cell 202a to the cell 202c. At that time, in the terminal equipment 300b, it is assumed that the channel quality of the base station 200c is higher by a predetermined threshold value or more than the channel quality of the base station 200a which is lowered with enlarged distance from the base station 200a. In such a case, the terminal equipment 300b performs the handover procedure described with reference to FIG. 1 and switches the connecting cell from the cell 202a to the cell 202c.

Here, the distance of the movement route extending within the area of the cell 202c is short. Therefore, in the slightly moved terminal equipment 300c, the next handover already occurs with decrease of the channel quality of the base station 200c, and then, the terminal equipment 300c switches the connecting cell from the cell 202c to the cell 202b. The terminal equipment 300 is to be the terminal equipment 300d as moving in a state of being connected to the cell 202b and ends the movement thereat.

Next, FIG. 3 illustrates the terminal equipment 300a as starting movement, the terminal equipment 300e as performing the first handover, and the terminal equipment 300d as ending movement. The terminal equipment 300a starts movement in a state of being connected to the cell 202a.

The terminal equipment 300e performs handover from the cell 202a to the cell 202b. At that time, in the terminal equipment 300e, it is assumed that the channel quality of the base station 200b is higher by a predetermined threshold value or more than the channel quality of the base station 200a which is lowered with enlarged distance from the base station 200a. In such a case, the terminal equipment 300e performs the handover procedure described with reference to FIG. 1 and switches the connecting cell from the cell 202a to the cell 202b.

Here, actually, the base station 200c provides the highest channel quality to the terminal equipment 300e. However, the terminal equipment 300e disregards the base station 200c with a method described in a later-mentioned embodiment of the present invention and switches connection to the cell 202b of the base station 200b.

Here, communication resource and time necessary for performing handover by the terminal equipment 300 are evaluated with the above examples of FIGS. 2 and 3. Accordingly, there may be a possibility that the order of “the cell 202a and the cell 202b” as illustrated in FIG. 3 is more appropriate as the switching order of cells to which the terminal equipment 300 is connected than the order of “the cell 202a, the cell 202c and the cell 202b” as illustrated in FIG. 2. In order to determine which order is more appropriate out of the above two orders, it is necessary to evaluate following conditions appropriately. For example, such conditions include time or distance of connection of the terminal equipment 300 to the cell 202c and whether or not the terminal equipment 300 may maintain a sufficient communication rate in the case that handover only from the cell 202a to the cell 202b is performed without connection of the terminal equipment 300 to the cell 202c.

### 2. Embodiment

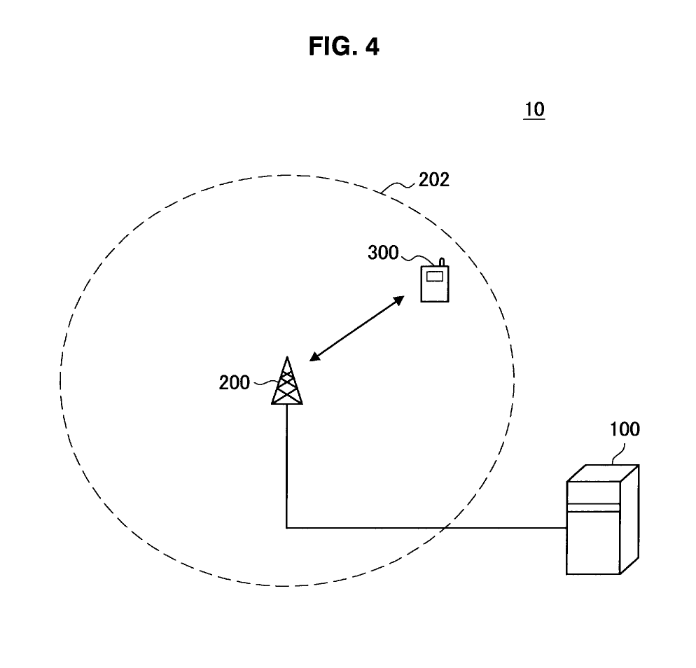

In the following, embodiments of the present invention will be described with reference to FIGS. 4 to 21.

### 2-1. Configuration of Wireless Communication System

Next, the configuration of a wireless communication system according to an embodiment of the present invention will be described with reference to FIG. 4. As illustrated in FIG. 4, a wireless communication system 10 includes a communication control apparatus 100, the base station 200, and the terminal equipment 300.

The base station 200 provides wireless communication service to terminal equipment in the cell 202. The base station 200 performs wireless communication with the terminal equipment 300 connected to the cell 202 and serves as an intermediary for the communication between the communication control apparatus 100 and the terminal equipment 300. Further, the base station 200 determines whether or not the terminal equipment 300 should perform handover to another cell based on the measurement report transmitted from the terminal equipment 300 connected to the cell 202.

The terminal equipment 300 performs wireless communication with the base station 200 as being connected to the cell 202. Further, the terminal equipment 300 may perform communication with the communication control apparatus 100 as well via the base station 200. The terminal equipment 300 transmits the measurement report containing channel quality of a base station of a neighboring cell to the base station 200. When the base station 200 determines that the terminal equipment 300 should perform handover to the other cell based on the measurement report, the terminal equipment 300 performs handover to the other cell. Further, the terminal equipment 300 provides position information containing the own position and a cell ID specifying the cell 202 to which the terminal equipment 300 is connected at the position thereof to the communication control apparatus 100.

The communication control apparatus 100 is placed to control handover performed by the terminal equipment 300. The communication control apparatus 100 performs communication with the base station 200. Further, via the base station 200, the communication control apparatus 100 may perform communication also with the terminal equipment 300 connected to the cell 202 to which wireless communication service is provided by the base station 200. Due to the communication, the communication control apparatus 100 acquires position information containing the position of the terminal equipment 300 and the cell ID specifying the cell 202 to which the terminal equipment 300 is connected at the position. Further, the communication control apparatus 100 provides, to the terminal equipment 300, recommended handover order data indicating connection order of cells to be recommended for the terminal equipment 300.

Here, it is also possible that the communication control apparatus 100 is placed, for example, as an MME being a host node of the base station 200 to be separated from the base station 200 and the terminal equipment 300 as illustrated in FIG. 4. Further, the communication control apparatus 100 may be also integrated with either the base station 200 or the terminal equipment 300.

### 2-2. Configuration of Communication Control Apparatus

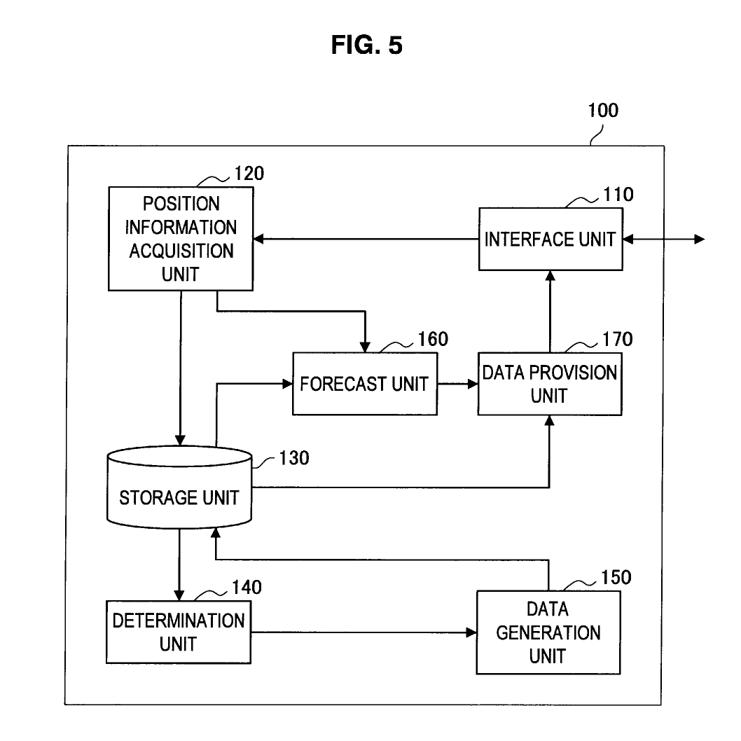

FIG. 5 is a block diagram illustrating an example of the configuration of the communication control apparatus 100 according to an embodiment of the present invention. As illustrated in FIG. 5, the communication control apparatus 100 includes an interface unit 110, a position information acquisition unit 120, a storage unit 130, a determination unit 140, a data generation unit 150, a forecast unit 160, and a data provision unit 170.

(Interface Unit)

The interface unit 110 is an interface serving as an intermediary for the communication of the communication control apparatus 100 with the base station 200. The interface unit 110 receives the position information of the terminal equipment 300 from the terminal equipment 300 via the base station 200. Further, the interface unit 110 transmits recommended handover order data indicating connection order of cells recommended for the terminal equipment 300 to the terminal equipment 300 via the base station 200.

(Position Information Acquisition Unit)

The position information acquisition unit 120 acquires the position information provided from the terminal equipment 300 through communication via the interface unit 110. The position information contains the position of the terminal equipment 300 and the cell ID specifying the cell 202 to which the terminal equipment 300 is connected at the position.

(Storage Unit)

The storage unit 130 stores position information history and cell information by utilizing a memory medium such as a hard disk and a semiconductor memory. Here, the position information history is the history of the position information of the terminal equipment 300 acquired by the position information acquisition unit 120. The cell information is the information for calculating estimation rate at an arbitrary position of each cell constituting the wireless communication system 10.

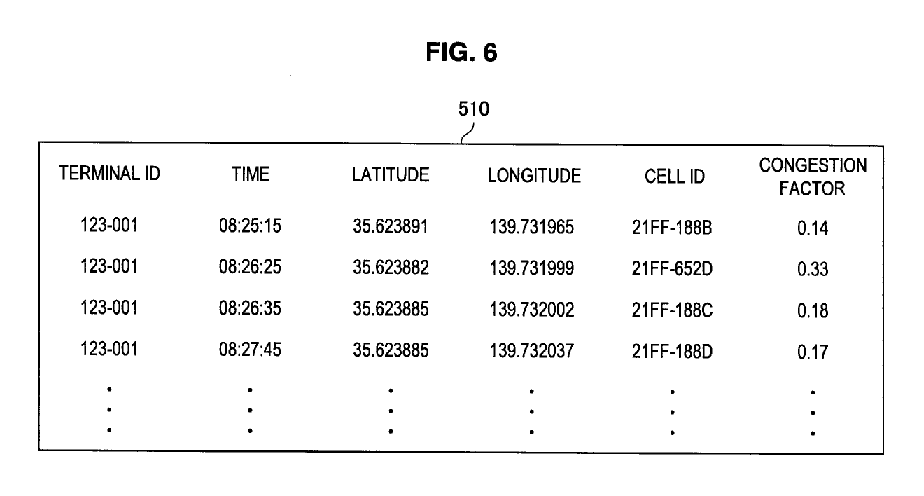

FIG. 6 is a view illustrating an example of position information history 510 stored in the storage unit 130. In the example of FIG. 6, the position information history 510 is a set of records of the position information of a terminal ID, time, latitude, longitude, a cell ID and a congestion factor which are respectively associated to one another. Here, the terminal ID is the ID to specify the terminal equipment 300 providing the position information. The time is time of detection of the position of the terminal equipment 300. The latitude and longitude are information indicating the position of the terminal equipment 300. The cell ID is the ID to specify the cell 202 to which the terminal equipment 300 is connected at the position indicated by the position information. The congestion factor is to indicate a degree of congestion of the cell 202, for example, by an S/N ratio and is contained in the position information appropriately.

Here, an international mobile subscriber identity (IMSI) or an integrated circuit card ID (ICCID) stored in a subscriber identity module (SIM) of the terminal equipment 300 may be employed as the terminal ID. However, except for the case that the communication control apparatus 100 is under the control of a communication common carrier, it is preferable to employ a different ID which is previously determined in view of security. For example, it is considered to employ an ID previously allocated by a carrier operating the communication control apparatus 100 to the terminal equipment 300 owned by a user contracting with the carrier.

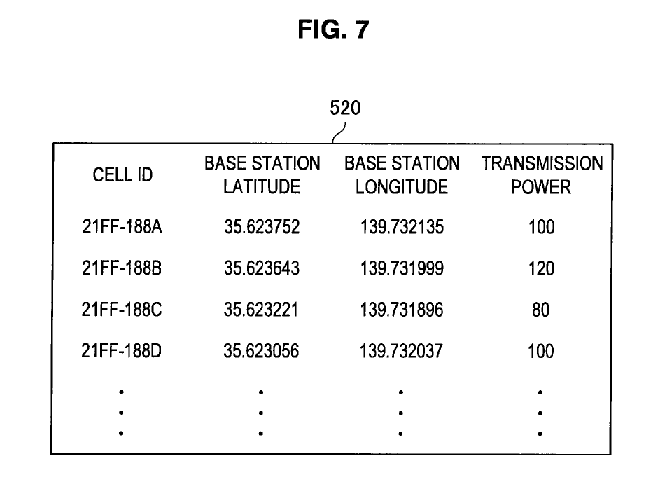

FIG. 7 is a view illustrating an example of cell information 520 stored in the storage unit 130. In the example of FIG. 7, the cell information 520 is a set of records of a cell ID, base station latitude, base station longitude and transmission power which are respectively associated to one another. Here, the cell ID is the ID to specify each cell in the wireless communication system 10 and is common to the cell ID contained in the position information history 510. The base station latitude and the base station longitude are information indicating the position of the base station of each cell. The transmission power is the transmission power utilized for transmission by the base station of each cell. A method to calculate the estimation rate at an arbitrary position of each cell constituting the wireless communication system 10 by utilizing the cell information will be described later.

(Determination Unit)

Referring to FIG. 5 once more, the determination unit 140 determines the cell to which the terminal equipment 300 should not have been connected. Specifically, the determination unit 140 determines whether or not connection of the terminal equipment 300 moving on the movement route corresponding to the position information history has been appropriate for each cell specified by each cell ID contained in the position information history of the terminal equipment 300 stored in the storage unit 130. The determination process to be performed by the determination unit 140 will be described later.

(Data Generation Unit)

The data generation unit 150 generates the recommended handover order data indicating connection order of cells to be recommended for the terminal equipment 300. Specifically, the data generation unit 150 generates the recommended handover order data indicating the connection order of cells to be recommended for the terminal equipment 300 by removing the cell ID specifying the cell determined to which the terminal equipment 300 should not have been connected by the determination unit 140 from the position information history of the terminal equipment 300. The generated recommended handover order data is stored in the storage unit 130.

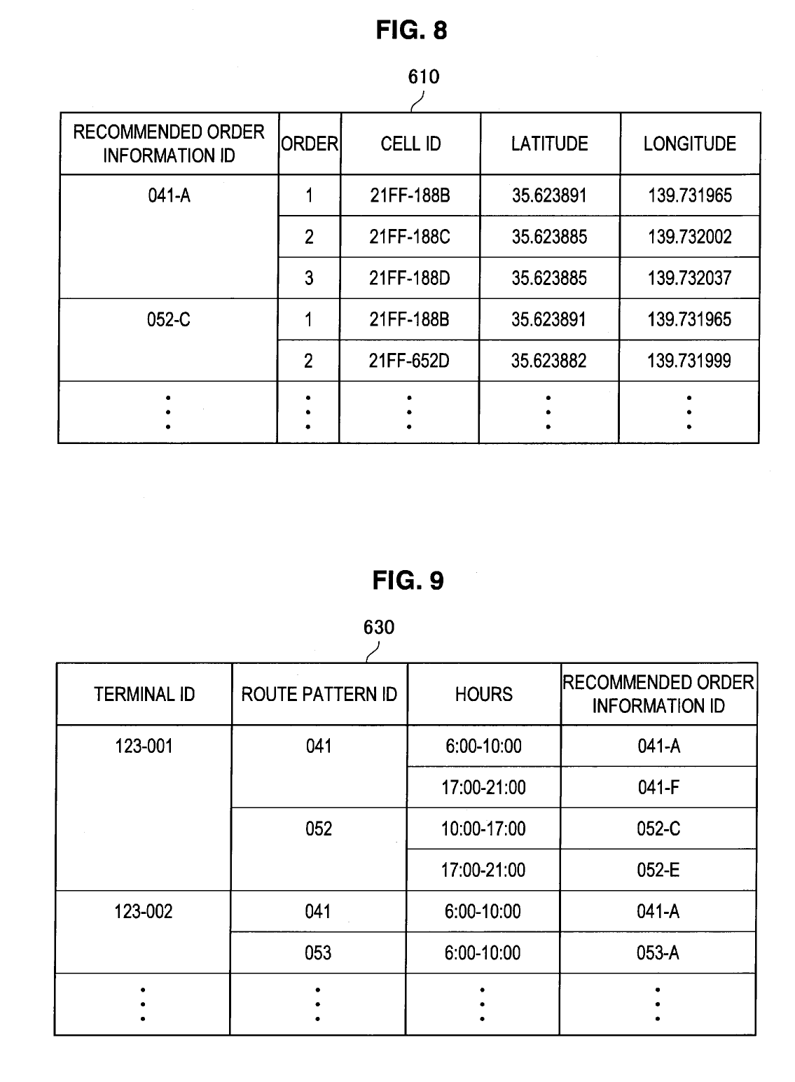

FIG. 8 is a view illustrating an example of recommended handover order data 610 stored in the storage unit 130. In the example of FIG. 8, the recommended handover order data 610 is a set of records of a recommended order information ID, an order, the cell ID, latitude and longitude which are associated to one another. Here, the recommended order information ID is the ID specifying a series of the recommended handover order data generated for one movement route of the terminal equipment 300. The order indicates the connection order of the respective cells to which the terminal equipment 300 is to be connected in the series of recommended handover order data specified by the recommended order information ID. The cell ID is the ID specifying the cell to which the terminal equipment 300 is to be connected and is common to the cell ID contained in the position information history 510 and the cell information 520. The latitude and longitude indicate the movement route of the terminal equipment 300 recommended for connection with the cell specified by the cell ID.

Further, the data generation unit 150 generates recommended handover order data related information for associating the recommended handover order data generated as above with the route information of the terminal equipment 300 and stores the data in the storage unit 130. As described later, the recommended handover order data related information is utilized when the data provision unit 170 provides the recommended handover order data to the terminal equipment 300.

FIG. 9 is a view illustrating an example of the recommended handover order data related information 630 stored in the storage unit 130. In the example of FIG. 9, the recommended handover order data related information 630 is a set of records of the terminal ID, a route pattern ID, hours and a recommended order information ID which are associated to one another. Here, the terminal ID is the ID specifying the terminal equipment 300 to be a target of the recommended handover order data and is common to the terminal ID contained in the position information history 510. The route pattern ID is the ID for specifying a route pattern categorizing the movement route of the terminal equipment 300. The route pattern ID will be described later. The hours are the hours to be targeted for the recommended handover order data. For example, in the case that the congestion factor of the cell largely varies corresponding to hours, hours to be a target of the recommended handover order data is specified by the time contained in the position information history 510 being the base of the recommended handover order data. The recommended order information ID is the ID for specifying a series of recommended handover order data generated for a single movement route of the terminal equipment 300 and is common to the recommended order information ID contained in the recommended handover order data 610.

Here, the recommended handover order data related information 630 may not necessarily contain the information of the hours. Further, in the case that the recommended handover order data may be shared among the respective terminal equipment, the recommended handover order data related information 630 may specify the recommended order information ID to be provided to the terminal equipment 300 only by the route pattern ID (and the hours) without containing the information of the terminal ID.

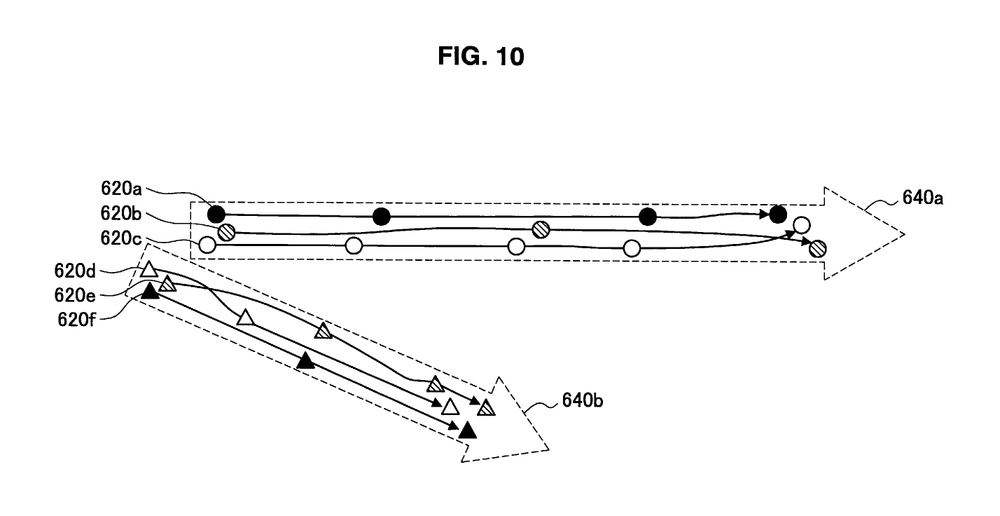

FIG. 10 is an explanatory view for describing the route pattern ID contained in the recommended handover order data related information 630. Referring to FIG. 10, movement routes 620a to 620f are the movement routes respectively corresponding to the position information history 510 provided at different time or by different terminal equipment. If the recommended handover order data generated from the position information history 510 corresponding to the movement routes are stored in the storage unit 130 as being directly corresponded to the respective movement routes, the recommended handover order data may be provided only to the terminal equipment 300 of which movement route is perfectly matched therewith in addition to having tremendous quantity of data.

Hence, the data generation unit 150 specifies movement routes within a certain range to be categorized into the same route pattern and manages each route pattern as providing the route pattern ID. In the example of FIG. 10, the movement routes 620a, 620b, 620c and the movement patterns 620d, 620e, 620f are respectively categorized into a route pattern 640a and a route pattern 640b. For example, daily movement routes of terminal equipment by a single user as daily repeated moving on a train of the same line or movement routes of respective terminal equipment by plural users as moving on a train of the same line may be associated with the recommended handover order data as assuming to be the same movement route by categorizing the movement routes into the route patterns as described above.

In this manner, in the case that the recommended handover order data is associated with the route pattern, the recommended handover order data stored in the storage unit 130 may be updated for each route pattern and accuracy of the recommended handover order data may be improved. For example, it is assumed that the terminal equipment 300 performs a series of handover in accordance with the previously generated recommended handover order data and provides the result to the communication control apparatus 100 as the position information history 510. Here, it is assumed that connection order to a cell which is not actually appropriate is contained in the previously generated recommended handover order data. In this case, it is expected that new recommended handover order data may be obtained without containing connection order to a cell which is not actually appropriate by generating the recommended handover order data from the provided position information history.

Referring to FIG. 5 once more, the forecast unit 160 forecasts a movement destination of the terminal equipment 300. For forecasting, the forecast unit 160 utilizes the position of the terminal equipment 300 contained in the position information acquired by the position information acquisition unit 120 from the moving terminal equipment 300 and the position information history stored in the storage unit 130.

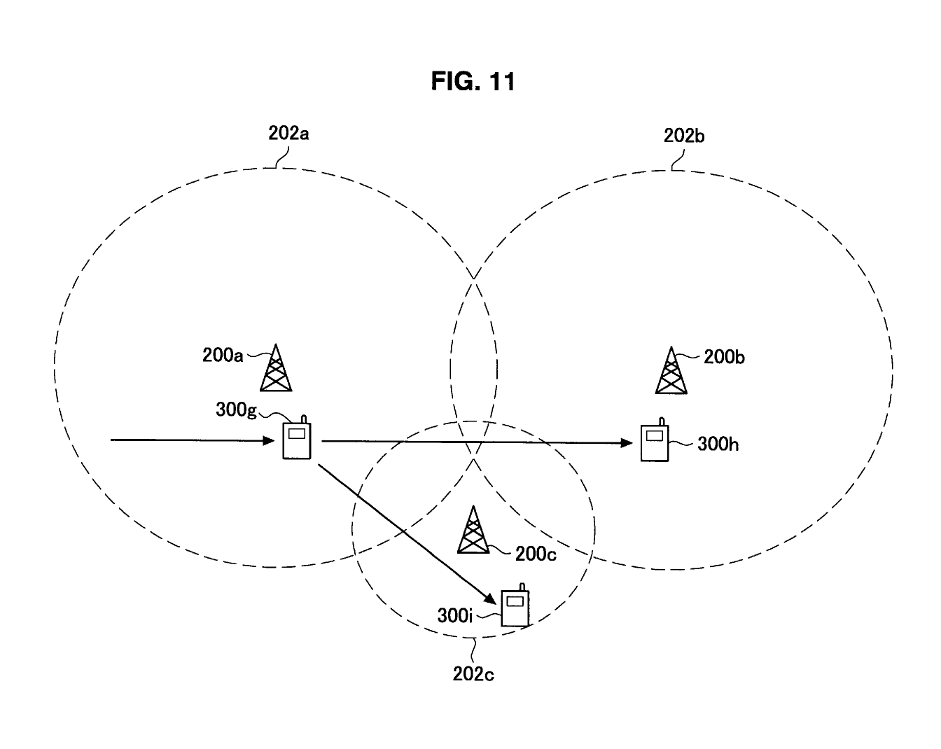

FIG. 11 is an explanatory view for describing an example of a process of forecasting the movement destination of the terminal equipment 300 to be performed by the forecast unit 160. Referring to FIG. 11, the terminal equipment 300g is assumed to be moving currently. In this case, there are plural possibilities for the subsequent movement destination of the terminal equipment 300g such as terminal equipment 300h and terminal equipment 300i.

Here, when the movement destination is the terminal equipment 300h, for example, the connection order of cells to be recommended for the terminal equipment 300 is “the cell 202a and the cell 202b”. On the other hand, when the movement destination is the terminal equipment 300i, the connection order of cells to be recommended for the terminal equipment 300 is “the cell 202a and the cell 202c”. In such a case, in order to provide the recommended handover order data more appropriately for the moving terminal equipment 300, the communication control apparatus 100 is desired to forecast the movement destination of the terminal equipment 300.

Here, the forecast unit 160 forecasts the movement destination of the terminal equipment 300 by utilizing the position provided from the moving terminal equipment 300 and the position information history stored in the storage unit 130. For example, the forecast unit 160 may forecast the movement destination of the terminal equipment 300 to be a point on the movement route corresponding to the position information history containing close position information to the position information provided so far this time by the moving terminal equipment 300 as referring to the position information history of the position information provided in the past by the moving terminal equipment 300.

Further, the forecast unit 160 may forecast the movement destination of the terminal equipment 300 as described above as referring to the position information history provided in the past by the terminal equipment other than the moving terminal equipment 300. By referring to the position information history provided in the past by the terminal equipment other than the moving terminal equipment 300, the movement destination of the terminal equipment 300 may be forecasted from the position information history of plural users who have moved on the same route.

Further, the forecast unit 160 may forecast the movement destination of the terminal equipment 300 from the position information history of the position information already provided by the moving terminal equipment 300 in the case that available past position information history does not exist, for example.

(Date Provision Unit)

Referring to FIG. 5 once more, the data provision unit 170 provides the recommended handover order data selected based on the destination of the terminal equipment 300 forecasted by the forecast unit 160 among one or more recommended handover order data stored in the storage unit 130 to the moving terminal equipment 300 via the interface unit 110.

Here, referring to FIG. 9 once more, a process performed by the data provision unit 170 to select the recommended handover order data to be provided to the moving terminal equipment 300 will be described. The data provision unit 170 refers to the recommended handover order data related information 630. For example, in order to select the recommended handover order data to be provided to the moving terminal equipment 300, the data provision unit 170 utilizes information of the terminal ID “123-001” contained in the position information acquired from the moving terminal equipment 300, the movement destination of the terminal equipment 300 forecasted by the forecast unit 160, and current time “18:20”. Here, it is assumed that both of the current position of the terminal equipment 300 and the movement destination of the terminal equipment 300 forecasted by the forecast unit 160 are points contained in the route pattern specified by the route pattern ID “041”.

In this case, when a record is found as searching the recommended handover order data related information 630 for the record complying with the above respective information, the data provision unit 170 provides the recommended handover order data specified by the recommended order information ID contained in the record to the terminal equipment 300. Specifically, the data provision unit 170 searches for the record under the conditions that the terminal ID is “123-001”, the route pattern ID is “041”, and the hours contains “18:20”. Consequently, the record containing the recommended order information ID “041-F” is specified in the example of FIG. 9. Then, the data provision unit 170 acquires the recommended handover order data specified by the recommended order information ID “041-F” from the storage unit 130 and provides the data to the terminal equipment 300 via the interface unit 110.

Here, among the above-described functions of the communication control apparatus 100, the functions of the position information acquisition unit 120, the determination unit 140, the data generation unit 150, the forecast unit 160 and the data provision unit 170 are actualized by utilizing a processing device such as a central processing unit (CPU) and a digital signal processor (DSP).

(Processes of Communication Control Apparatus)

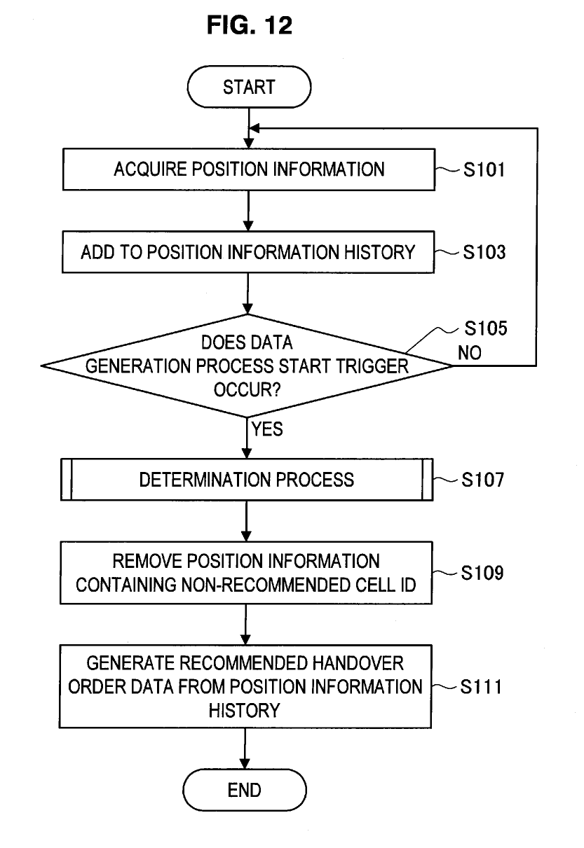

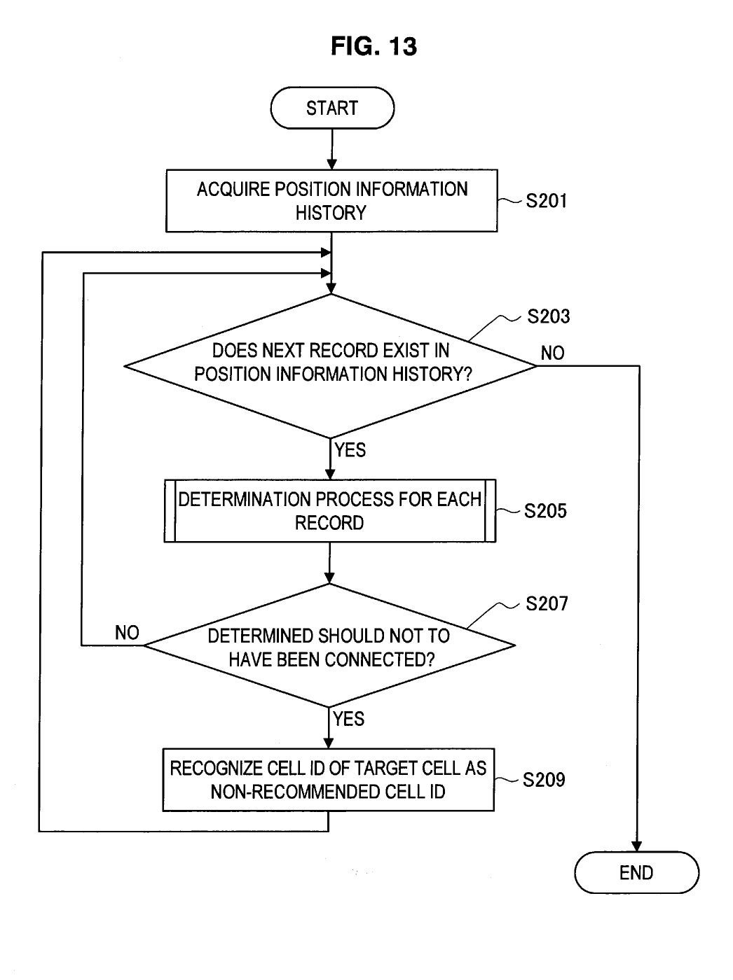

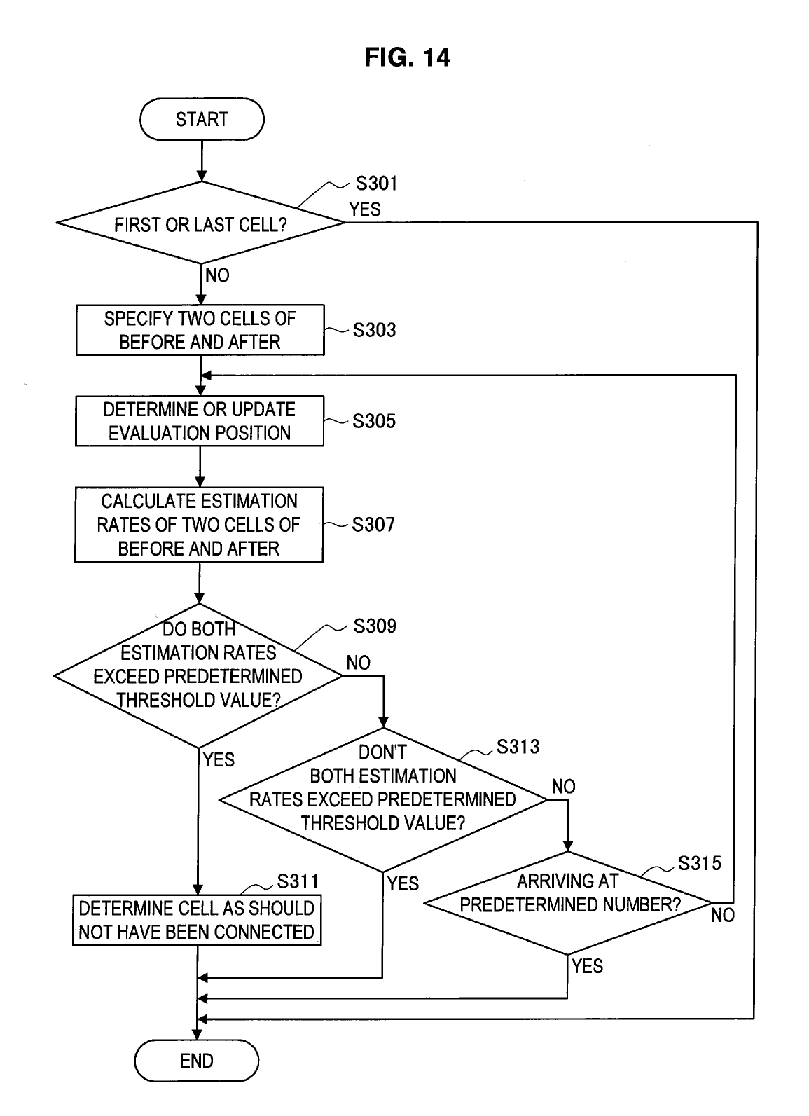

In the following, processes of the communication control apparatus 100 according to an embodiment of the present invention will be described with reference to FIGS. 12 to 14. Here, FIG. 12 describes a general outline of the process to be performed by the communication control apparatus 100. FIG. 13 further describes the process of step S107 in FIG. 12 in detail. FIG. 14 further describes the process of step S205 in FIG. 13 in detail.

FIG. 12 is a flowchart describing a general outline to be performed by the communication control apparatus 100 according to an embodiment of the present invention. Referring to FIG. 12, the position information acquisition unit 120 firstly acquires the position information of the terminal equipment 300 via the interface unit 110 (step S101).

Next, the position information acquisition unit 120 adds the acquired position information of the terminal equipment 300 to the position information history stored in the storage unit 130 (step S103). In the case that the position information is the firstly acquired position information, the position information history having the position information as the first record is newly generated.

Further, the position information acquisition unit 120 determines whether or not a predetermined data generation process start trigger occurs (step S105). Here, the communication control unit 100 repeats the process of step S101 and step S103 until the data generation process start trigger occurs. For example, non-acquisition of the position information from the terminal equipment 300 by the position information acquisition unit 120 for a certain time, arriving of the number of records of the position information history stored in the storage unit 130 at a predetermined number, or starting time of a batch process to be periodically performed is conceivable as the data generation process start trigger.

In the case that a predetermined data generation process start trigger occurs in step S105, the determination process is firstly performed by the determination unit 140 (step S107). Here, the determination unit 140 determines the cell satisfying predetermined conditions to which the terminal equipment 300 should not have been connected among the cells specified by the cell IDs contained in the position information history and recognizes the cell ID specifying the cell as a non-recommended cell ID. Details of the determination process will be described later with reference to FIG. 13.

Subsequently, the data generation unit 150 removes the position information containing the non-recommended cell ID recognized by the determination unit 140 from the position information history (step S109).

Further, the data generation unit 150 generates the recommended handover order data constituted with cell IDs staying in the position information history as a result of the above process in step S109 and the latitude and longitude associated with each cell ID (step S111).

(Process of Determination Unit)

FIG. 13 is a flowchart describing the determination process performed by the determination unit 140 of step S107 in FIG. 12. Referring to FIG. 13, the determination unit 140 firstly acquires the position information history stored in the storage unit 130 (step S201). The acquired position information history is the position information history corresponding to a series of movement of a terminal equipment.

Next, the determination unit 140 sequentially performs a process against respective position information contained in the position information history. The determination unit 140 determines whether or not a record of the next position information exists in the position information history (step S203). In the case that the next position information record exists, the determination unit 140 performs a process of subsequent steps on the position information record as the process target.

Subsequently, regarding the cell specified by the cell ID contained in the position information record as being the above process target (hereinafter, called the target cell), the determination unit 140 performs the determination process for each record to determine whether or not the terminal equipment 300 should have been connected to the target cell (step S205). Details of the determination process for each record will be described later with reference to FIG. 14.

If it is determined that the terminal equipment 300 should not have been connected to the target cell in the process of step S205 (step S207), the determination unit 140 recognizes the cell ID specifying the target cell as the non-recommended cell ID (step S209). If it is not the case, the determination unit 140 proceeds to the process on the record of the next position information (step S203).

The determination unit 140 repeats the process between steps S205 and S209 on the records of the respective position information contained in the position information history as the target. When the process is performed on all of the position information contained in the position information history (step S203), the determination process by the determination unit 140 is completed.

FIG. 14 is a flowchart describing the determination process for each record performed by the determination unit 140 in step S205 of FIG. 13.

Referring to FIG. 14, the determination unit 140 firstly determines whether or not the target cell is the cell specified by the cell ID contained in the first or last position information in the position information history (step S301). Here, in the case that the target cell is the cell specified by the cell ID contained in the first or last position information of the position information history, the determination unit 140 ends the process on the target cell.

Next, the determination unit 140 specifies two cells before and after the target cell (step S303). Here, the two cells before and after denote two cells to which the terminal equipment 300 has been connected respectively right before and right after connecting to the target cell. That is, the above are the cell of the source base station when the terminal equipment 300 performs handover having the base station of the target cell being the target base station and the cell of the target base station when the terminal equipment 300 performs handover having the base station of the target cell being the source base station.

Next, the determination unit 140 determines an evaluation position in the target cell (step S305). For example, the evaluation position is a position between the position at which connection of the terminal equipment 300 to the target cell is started and the position at which connection of the terminal equipment 300 to the target cell is ended.

Next, the determination unit 140 calculates the estimation rate of each of the two cells before and after the target cell at the determined evaluation position (step S307). The estimation rate calculated in the above is the rate estimated as being a communication rate obtained in the case that the terminal equipment is assumed to be connected to either of the two cells of the before and after not to the target cell at the evaluation position.

Here, calculation of the estimation rates for the two cells before and after the target cell is performed by utilizing the cell information stored in the storage unit 130. As described with reference to FIG. 7, for example, the cell information is a set of records of the cell ID, the base station latitude, the base station longitude and the transmission power which are respectively associated to one another. The determination unit 140 estimates the rate obtained in the case that the terminal equipment 300 is connected to either of the two cells of the before and after at the evaluation position for each of the cells of the before and after by utilizing the cell information.

The determination unit 140 may calculate the estimation rate at an arbitrary position of each cell with a calculation expression as described below, for example. First, distance D from the base station to the terminal equipment located at an arbitrary position may be acquired by the following calculation expression. Here, the base station latitude is denoted by θ_{BS}, the base station longitude is denoted by φ_{BS}, the latitude and longitude of the terminal equipment located at an arbitrary position are denoted by θ_{UE} and φ_{UE}, and the radius of the earth is denoted by R.

D=R arccos(cos θ_{BS} cos φ_{BS} cos θ_{UE} cos φ_{UE}+cos θ_{BS} sin φ_{BS} cos θ_{UE} sin φ_{UE}+sin θ_{BS} sin θ_{UE}) E) Expression 1

Next, the reception power P_{UE} at the terminal equipment located at an arbitrary position may be acquired with the following expression. Here, the transmission power is denoted by P_{BS} and wavelength of radio waves is denoted by λ.

$${P}_{UE} = {P}_{BS} ( \frac{λ}{4 π D} ) 2 \qquad Expression 2$$

The reception power P_{UE} of the terminal equipment located at an arbitrary position as calculated above may be associated with a channel quality indicator (CQI) with a predetermined table which is determined for each communication specification. Accordingly, the CQI may be estimated from the value of the reception power P_{UE}. Further, by dividing a transport block size contained in the CQI by a transmission time interval (TTI) determined for each communication specification, the estimation rate of the terminal equipment located at an arbitrary position may be obtained.

Here, in the case that information such as an S/N ratio when the terminal equipment 300 is connected to the two cells of the before and after may be acquired from the position information history, the determination unit 140 may additionally utilize such information as a value indicating the congestion factor of the cell to calculate the estimation rate. In this case, it is possible, for example, to multiply the values of the above estimation rate, the reception power P_{UE}, the transport block size and the like by a coefficient as being inversely proportional to the congestion factor.

In this manner, by reflecting an element of the congestion factor to the estimation rate, the estimation rate of higher accuracy being close to the actually obtained rate may be obtained. As the accurate estimation rate being obtained, the recommended handover order data generated through evaluation of the estimation rate may indicate a more appropriate connection order of cells.

Consequently, the determination unit 140 determines whether or not both of the calculated estimation rates of the two cells of the before and after exceed a predetermined threshold value (step S309). For example, the predetermined threshold value may be a fixed value or may be a constant-times (e.g., 0.8 times) of the rate of the target cell. In the case that the terminal equipment 300 is provided with service of a rate-guaranteed type, the predetermined threshold value is a predetermined rate which is guaranteed in the service.

Here, when both of the estimation rates of the two cells before and after the target cell exceed the predetermined threshold value in step S309, the determination unit 140 determines that the target cell is the cell to which the terminal equipment 300 should not have been connected (step S311). That is, it is estimated that the terminal equipment 300 were able to obtain a sufficient communication rate even when handover was to be performed between the two cells of the before and after without connecting the terminal equipment 300 to the target cell. Accordingly, looking overall of the series of handover performed by the terminal equipment 300, the handover for connecting to the target cell is not necessary and the target cell is determined to be the cell to which the terminal equipment 300 should not have been connected.

On the other hand, when at least one of the estimation rates of the two cells before and after the target cell does not exceed the predetermined threshold value in step S309, the determination unit 140 determines whether or not both of the estimation rates of the estimation rates of the two cells before and after the target cell do not exceed the predetermined threshold value (step S313).

Here, when both of the estimation rates of the two cells before and after the target cell do not exceed the predetermined threshold value, the determination unit 140 ends the process without determining the target cell to be the cell to which the terminal equipment 300 should not have been connected. That is, it may be estimated that a sufficient communication rate may not be obtained at least at the above evaluation position provided that the terminal equipment 300 is not connected to the target cell between the two cells of the before and after. Accordingly, in this case, the target cell is not determined to be the cell to which the terminal equipment 300 should not have been connected.

On the other hand, when either of the estimation rates of the two cells before and after the target cell exceeds the predetermined threshold value in step S313, the determination unit 140 determines whether or not the number of processing times between steps S307 and S313 on the target cell arrives at a predetermined number (step S315).

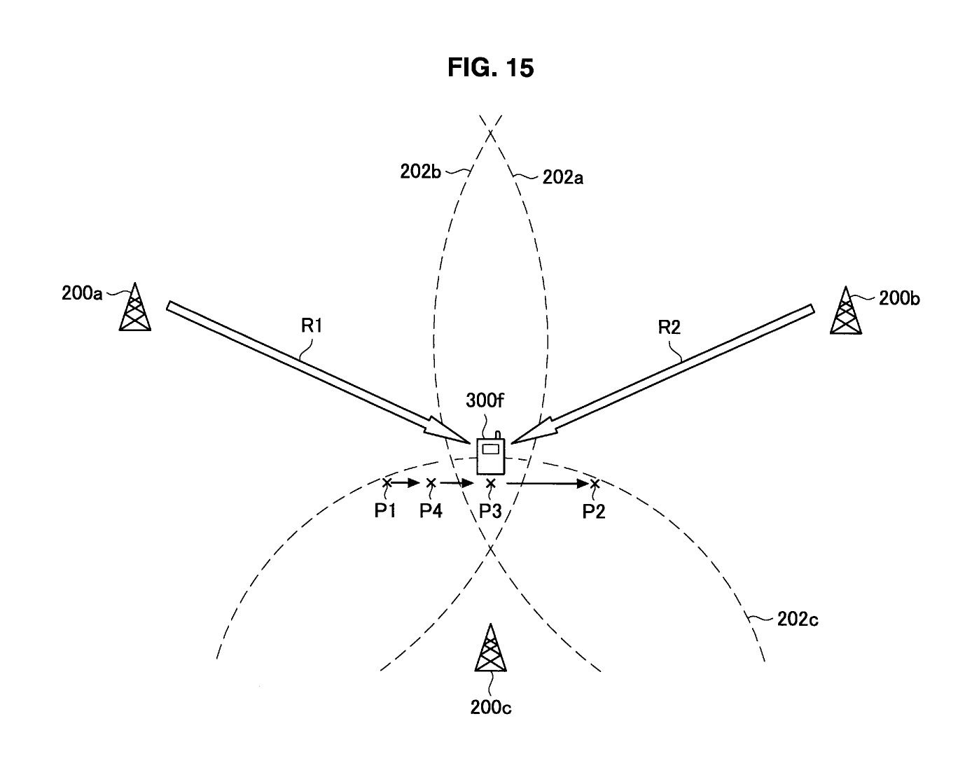

Here, when the number of processing times does not arrive at the predetermined number, the determination unit 140 updates the evaluation position in the target cell (step S305). The update of the evaluation position will be described later with reference to FIG. 15.

On the other hand, when the number of processing times has arrived at the predetermined number in step S315, the determination unit 140 ends the process without determining the target cell to be the cell to which the terminal equipment 300 should not have been connected.

FIG. 15 is an explanatory view for describing an estimation rate calculation process at the evaluation position and an update process of the evaluation position which are to be performed by the determination unit 140. In the example of FIG. 15, when the target cell is assumed to be the cell 202c, the two cells of the before and after are to be the cell 202a and the cell 202b.

First, the determination unit 140 sets the evaluation position at the position P3 being a midpoint between the position P1 at which connection of the terminal equipment 300 to the target cell is started and the position P2 at which connection of the terminal equipment 300 to the target cell is ended. Subsequently, the determination unit 140 respectively estimates an estimation rate R1 in the case that the terminal equipment 300f located at the evaluation position P3 is assumed to be connected to the cell 202a and an estimation rate R2 in the case that the terminal equipment 300f is assumed to be connected to the cell 202b.

Here, it is assumed that the estimation rate R1 falls below the predetermined threshold value and the estimation rate R2 exceeds the predetermined value. In this case, the determination unit 140 sets a new evaluation position to be a position P4 being a midpoint between the original evaluation position P3 and the position P1 being a boundary point of the base station 200a side of which estimation rate falls below the predetermined value. Similarly, the determination unit 140 repeats updating of the evaluation position by the predetermined number of processing times.

The above updating of the evaluation position is performed to detect a position at which the terminal equipment 300 are estimated to have obtained sufficient communication rate even when handover is performed between the two cells of the before and after. Hence, in the case that only the estimation rate of one cell falls below the predetermined threshold value at the midpoint, the estimation rate is obtained once more as moving the evaluation position in the direction being expected to be closer to the base station of the cell falling below the threshold value.

(Processes of Forecast Unit and Data Provision Unit)

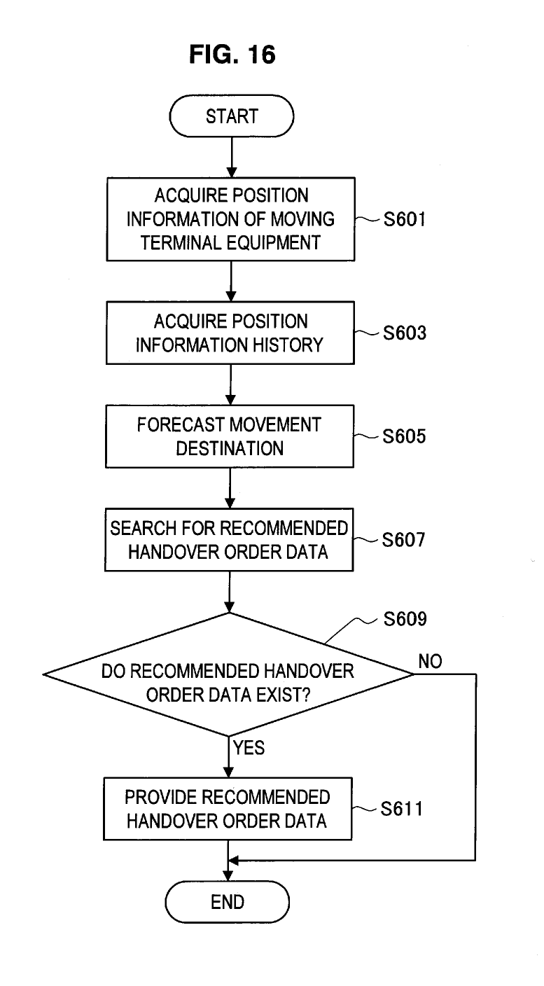

FIG. 16 is a flowchart describing a general outline of processes to be performed by the forecast unit 160 and the data provision unit 170 of the communication control apparatus 100 according to an embodiment of the present invention.

Referring to FIG. 16, the forecast unit 160 firstly acquires the position information of the moving terminal equipment 300 (step S601). Here, the position information acquired by the position information acquisition unit 120 may be directly used or the position information which is acquired and stored once in the storage unit 130 may be used.

Next, the forecast unit 160 acquires the position information history necessary for forecasting the movement destination of the terminal equipment 300 from the storage unit 130 (step S603).

Here, as described above, the position information history acquired here contains the position information history with at least the position information provided so far this time by the terminal equipment 300. In addition, the position information history acquired here contains either or both of the position information history with the position information provided in the past by the terminal equipment 300 and the position information history with the position information provided by the terminal equipment other than the terminal equipment 300.

Subsequently, the forecast unit 160 forecasts the movement destination of the terminal equipment 300 from the position information of the terminal equipment 300 acquired in step S601 and the position information history acquired in step S603 (step S605).

Further, the data provision unit 170 searches for the movement route pattern corresponding to the movement route of the terminal equipment 300 by utilizing the position information history with the position information provided so far this time by the terminal equipment 300 and the movement destination of the terminal equipment 300 forecasted by the forecast unit 160. When the corresponding moving route pattern exists, the data provision unit 170 searches for the recommended handover order data to be provided to the terminal equipment 300 as referring to the recommended handover order data related information stored in the storage unit 130 (step S607).

Next, the data provision unit 170 determines whether or not the recommended handover order data to be provided to the terminal equipment 300 exists as a result of searching in step S607 (step S609). Here, when the recommended handover order data to be provided exists, the data provision unit 170 provides the recommended handover order data to the terminal equipment 300 via the interface unit 110 (step S611).

On the other hand, when the moving route pattern corresponding to the movement route of the terminal equipment 300 does not exist in step S607, the data provision unit 170 ends the process. Further, when the recommended handover order data to be provided to the terminal equipment 300 does not exist as a result of referring to the recommended handover order data related information, the data provision unit 170 ends the process as well.

### 2-3. Configuration of Base Station

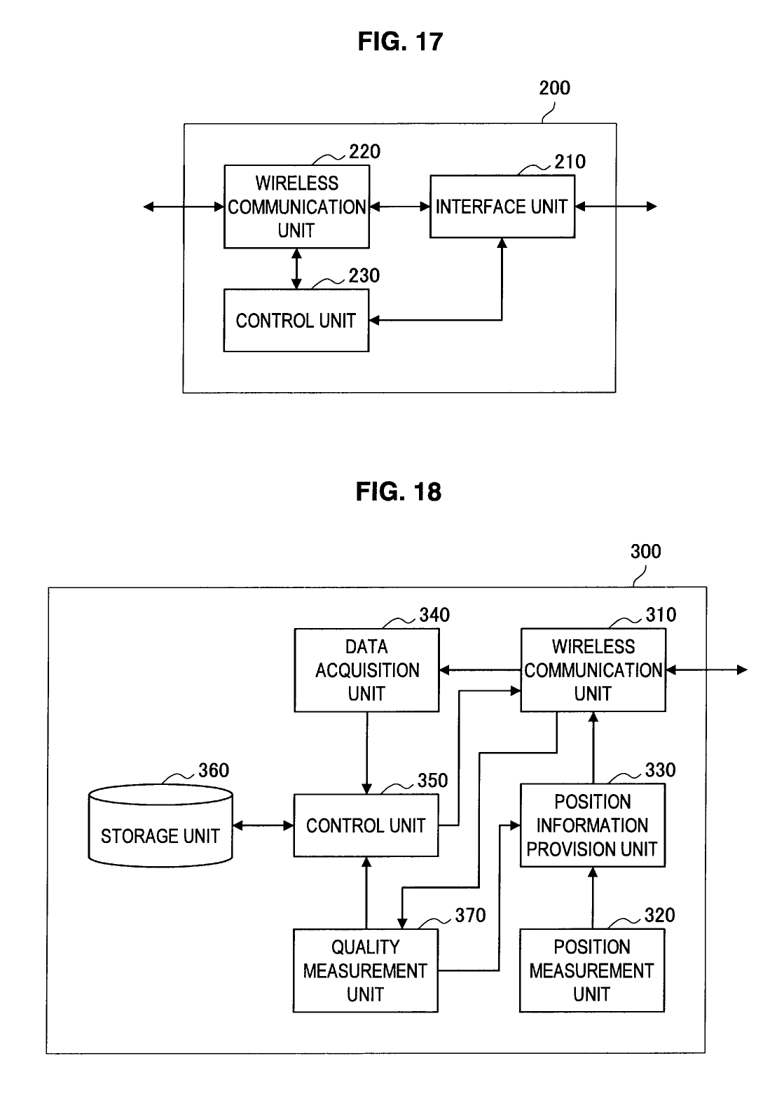

FIG. 17 is a block diagram illustrating an example of the configuration of the base station 200 according to an embodiment of the present invention. Referring to FIG. 17, the base station 200 includes an interface unit 210, a wireless communication unit 220, and a control unit 230.

The interface unit 210 is an interface serving as an intermediary for the communication of the base station 200 with the communication control apparatus 100. The interface unit 210 transmits the position information of the terminal equipment 300 inputted from the wireless communication unit 220 to the communication control apparatus 100. Further, the interface unit 210 receives the recommended handover order data indicating the connection order of cells recommended for the terminal equipment 300 from the communication control apparatus 100 and outputs the data to the wireless communication unit 220.

The wireless communication unit 220 performs wireless communication with the terminal equipment 300. The wireless communication unit 220 receives the position information of the terminal equipment 300 from the terminal equipment 300 and output the information to the interface unit 210. Further, the wireless communication unit 220 receives the recommended handover order data indicating recommended connection order of cells from the interface unit 210 and transmits the data to the terminal equipment 300. Furthermore, the wireless communication unit 220 receives the measurement report from the terminal equipment 300 and inputs the report to the control unit 230.

The control unit 230 determines whether or not the terminal equipment 300 should perform handover based on content of the measurement report received from the terminal equipment 300. The function of the control unit 230 is actualized by utilizing a processing device such as a CPU and a DSP.

### 2-4. Configuration of Terminal Equipment

FIG. 18 is a block diagram illustrating an example of the configuration of the terminal equipment 300 according to an embodiment of the present invention. Referring to FIG. 18, the terminal equipment 300 includes a wireless communication unit 310, a position measurement unit 320, a position information provision unit 330, a data acquisition unit 340, a control unit 350, a storage unit 360, and a quality measurement unit 370.

(Wireless Communication Unit)

The wireless communication unit 310 performs wireless communication with the base station 200. The wireless communication unit 310 transmits the position information of the terminal equipment 300 inputted from the position information provision unit 330 via the base station 200 to the communication control apparatus 100. Further, the wireless communication unit 310 receives the recommended handover order data indicating connection order of cells recommended for the terminal equipment 300 from the communication control apparatus 100 and outputs the data to the data acquisition unit 340. Further, the wireless communication unit 310 transmits the measurement report inputted from the control unit 350 to the base station 200.

(Measurement Unit)

The position measurement unit 320 acquires the position of the terminal equipment 300. The position measurement unit 320 has an antenna for a global positioning system (GPS), for example, and calculates latitude and longitude of the terminal equipment 300 based on the received data via the antenna. Alternatively, the position measurement unit 320 may acquire the position of the terminal equipment 300 with another known method. The position measurement unit 320 outputs the acquired position of the terminal equipment 300 to the position information provision unit 330.

(Position Information Provision Unit)

The position information provision unit 330 generates the position information containing the position of the terminal equipment 300 which is inputted from the position measurement unit 320 and the cell ID inputted from the control unit 350 as specifying the cell to which the terminal equipment 300 is connected at the position and provides the position information to the communication control apparatus 100 via the wireless communication unit 310 and the base station 200.

Here, the generation of the position information and the provision of the generated position information to the communication control apparatus 100 by the position information provision unit 330 may be continuously performed during power is supplied to the terminal equipment 300 or may be performed only during operation of a specific application with which the terminal equipment 300 relies on high rate data communication.

Further, the generation of the position information and the provision of the generated position information to the communication control apparatus 100 by the position information provision unit 330 may be performed only at the timing when the terminal equipment 300 performs handover or may be periodically performed other than the timing when the terminal equipment 300 performs handover.

Further, the position information provision unit 330 may provide the generated position information accordingly to the communication control apparatus 100. Alternatively, the position information provision unit 330 stores the generated position information in the storage unit 360 and provides the information to the communication control apparatus 100 collectively at predetermined timing.

The timing of the generation of the position information and the provision of the generated position information to the communication control apparatus 100 by the position information provision unit 330 is determined in consideration of several conditions. For example, when the generated and provided position information is large in quantity, accuracy of the recommended handover order data generated at the communication control apparatus 100 and forecast accuracy of the movement destination of the terminal equipment 300 at the communication control apparatus 100 are improved. However, in this case, overhead of the terminal equipment 300 with generation and provision of the position information and traffic of the wireless communication performed by the wireless communication unit 310 are increased.

On the other hand, when the generated and provided position information is small in quantity, accuracy of the recommended handover order data generated at the communication control apparatus 100 and forecast accuracy of the movement destination of the terminal equipment 300 at the communication control apparatus 100 are decreased. However, in this case, overhead of the terminal equipment 300 with generation and provision of the position information and traffic of the wireless communication performed by the wireless communication unit 310 may be reduced.

Accordingly, in order to optimize the recommended handover order data generated by the communication control apparatus 100, it is preferable, for example, that the terminal equipment 300 provides the position information to the communication control apparatus 100 periodically even other than the timing of performing handover continuously during power is supplied. This is because accurate recommended handover order data can be generated as acquiring more position information by the communication control apparatus 100 with the above configuration.

However, in the case that the overhead with generation and provision of the position information by the terminal equipment 300 becomes an issue, it is also possible that the generation and provision of the position information by the terminal equipment 300 is limited to during operation of a specific application or to only the timing when handover is performed. Accordingly, although accuracy of the recommended handover order data is decreased, the overhead of the terminal equipment 300 may be suppressed.

(Data Acquisition Unit)

The data acquisition unit 340 acquires the recommended handover order data generated by the communication control apparatus 100 as indicating connection order of cells recommended for the terminal equipment 300 via the base station 200 and the wireless communication unit 310.

(Control Unit)

The control unit 350 controls wireless communication with the wireless communication unit 310 so that a series of handover performed by the terminal equipment 300 is to be performed in accordance with the connection order of cells recommended for the terminal equipment 300. The connection order of cells recommended for the terminal equipment 300 is indicated by the recommended handover order data acquired by the data acquisition unit 340. For example, the control unit 350 varies the measurement value of each cell contained in the measurement report generated by the quality measurement unit 370 in accordance with whether or not the cell ID specifying the cell is contained in the recommended handover order data. Further, the control unit 350 outputs the measurement report containing the varied measurement value to the wireless communication unit 310.

As the above variation of the measurement value, it is conceivable to add a negative offset to the measurement value of the cell specified by the cell ID which is not contained in the recommended handover order data, for example. Here, adding a negative offset means to subtract a predetermined value from the measurement value of the cell or to multiply the measurement value of the cell by a weighting coefficient which is smaller than 1, for example.

By varying the measurement value contained in the measurement report as describe above, measurement values of cells other than the cell specified by the cell ID contained in the recommended handover order data become relatively small. Accordingly, when the base station 200 determines whether or not the terminal equipment 300 should perform handover with reference to the measurement report, the possibility to be determined that handover should be performed becomes low for cells other than the cell specified by the cell ID contained in the recommended handover order data.

(Storage Unit)

The storage unit 360 stores data by utilizing a storage medium such as a semiconductor memory. The storage unit 360 stores data necessary for the control unit 350 to perform processes. For example, the storage unit 360 is utilized as a temporal storage area for the recommended handover order data acquired by the data acquisition unit 340 and the measurement report generated by the quality measurement unit 370.

(Quality Measurement Unit)

The quality measurement unit 370 performs measurement by utilizing a reference signal contained in the downlink channel from a base station of a neighboring cell and generates the measurement report to be transmitted to the base station 200 by the control unit 350 via the wireless communication unit 310. Further, it is possible for the quality measurement unit 370 to measure an S/N ratio of the cell to which the terminal equipment 300 is connected and to provide the S/N ratio to the position information provision unit 330 as a numerical value indicating a congestion factor.

Here, among the above functions of the terminal equipment 300, the functions of the position measurement unit 320, the position information provision unit 330, the data acquisition unit 340, the control unit 350 and the quality measurement unit 370 may be actualized by utilizing a processing device such as a central processing unit (CPU) and a digital signal processor (DSP).

(Process of the Control Unit)

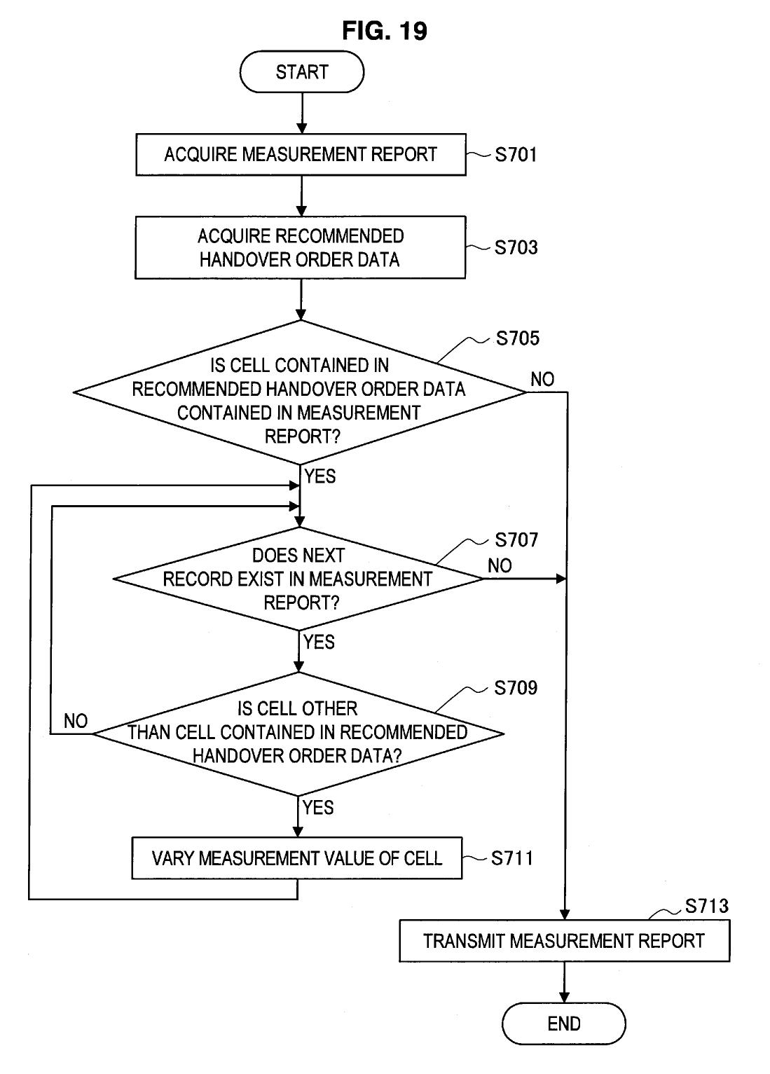

FIG. 19 is a flowchart describing process to be performed by the control unit 350 of the terminal equipment 300 according to an embodiment of the present invention to vary the measurement value of the measurement report. The process is performed at the timing when the measurement report is generated by the quality measurement unit 370.

Referring to FIG. 19, the control unit 350 firstly acquires the measurement report (step S701). Here, the measurement report to be acquired may be temporally stored in the storage unit 360 after being generated by the quality measurement unit 370.

Subsequently, the control unit 350 acquires the recommended handover order data (step S703). Here, the recommended handover order data to be acquired is acquired by the data acquisition unit 340 and temporally stored in the storage unit 360.

Further, the control unit 350 determines whether or not the cell specified by the cell ID contained in the recommended handover order data is contained in the cells being targets of the measurement values contained in the measurement report (step S705).

Here, when the cell specified by the cell ID contained in the recommended handover order data is contained in the measurement report, the control unit 350 performs the process to vary the measurement value of the measurement report. On the other hand, when the cell specified by the cell ID contained in the recommended handover order data is not contained in the measurement report, the control unit 350 transmits the measurement report as-is to the base station 200 via the wireless communication unit 310 (step S713).

The control unit 350 sequentially performs the process to vary the measurement value having information of each cell contained in the measurement report as one record. The control unit 350 determines whether or not the next record exists in the measurement report (step S707). When the next record exists in the measurement report, the control unit 350 performs the subsequent step of the process having the record as the target.

Next, the control unit 350 determines whether or not the cell of the target record is the cell other than the cell specified by the cell ID contained in the recommended handover order data (step S709).

Here, when the cell of the target record is the cell other than the cell specified by the cell ID contained in the recommended handover order data, the control unit 350 varies the measurement value of the cell of the target record (step S711). As the above variation of the measurement value, it is conceivable to add a negative offset to the measurement value of the cell specified by the cell ID which is not contained in the recommended handover order data, for example. Adding a negative offset means to subtract a predetermined value from the measurement value of the cell or to multiply the measurement value of the cell by a weighting coefficient which is smaller than 1, for example.

On the other hand, when the cell of the target record is the cell contained in the recommended handover order data in step S709, the control unit 350 proceeds to the process on the next record without varying the measurement value of the target record (step S707).

With the above process, measurement values of the cells other than the cell specified by the cell ID contained in the recommended handover order data become relatively small. Accordingly, when the base station 200 determines whether or not the terminal equipment 300 should perform handover with reference to the measurement report, the possibility to be determined that handover should be performed becomes low for cells other than the cell specified by the cell ID contained in the recommended handover order data.

When it is determined that the record does not exist in the measurement report in step S707, the control unit 350 transmits the measurement report of that time to the base station 200 via the wireless communication unit 310.

### 2-5. Modified Examples

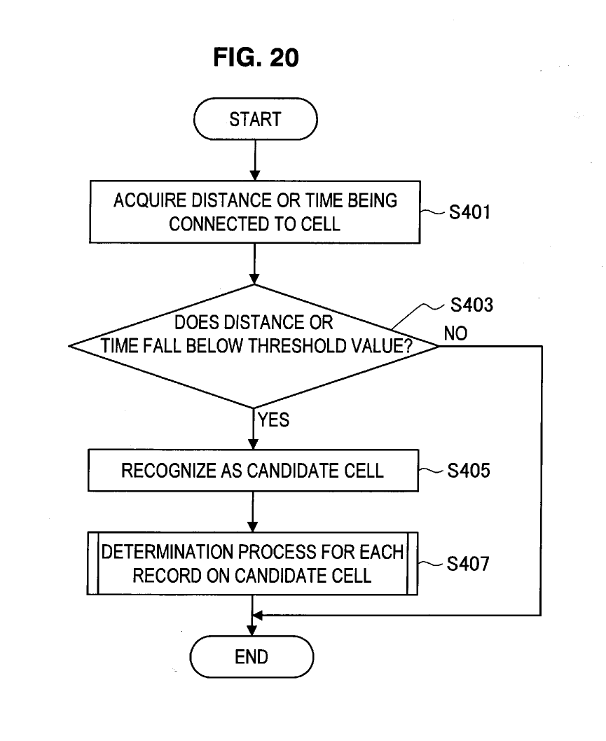

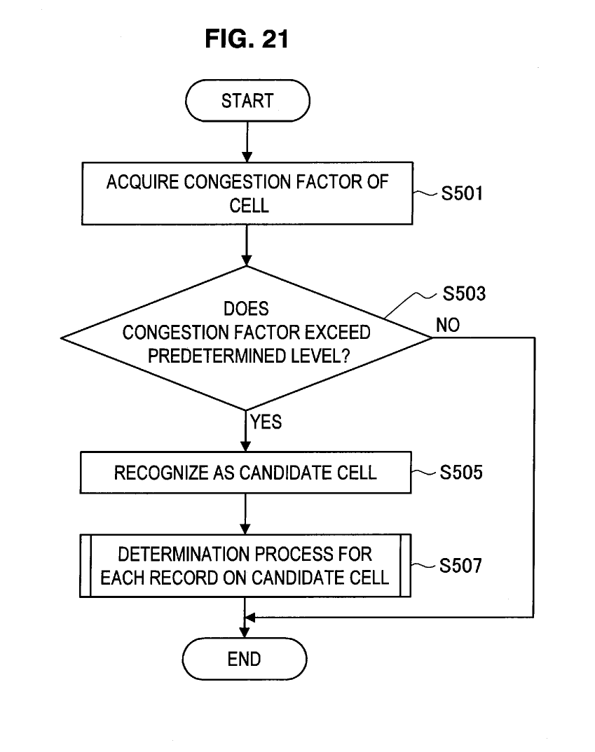

Here, modified examples of the process to be performed by the determination unit 140 of the communication control apparatus 100 according to the present embodiment will be described with reference to FIGS. 20 and 21.

### First Modified Example

First, the first modified example will be described with reference to FIG. 20. FIG. 20 is a flowchart describing an example of process to be performed by the determination unit 140 to limit the records being the target for the determination process on each record to a record of a candidate cell satisfying predetermined conditions. The process is performed in step S205 of FIG. 13 as describe above.

Referring to FIG. 20, regarding the cell (hereinafter, called the target cell) specified by the cell ID contained in the record of the position information to be a process target, the determination unit 140 firstly calculates connected time or connected distance of the terminal equipment 300 to the target cell from a position or time contained in the position information history (step S401). Here, the time is calculated as the difference between time when performing handover to the target cell and time when performing handover from the target cell by the terminal equipment 300 contained in the position information among the position information history. Further, the distance is calculated as the distance between two points being a position where performing handover to the target cell and a position where performing handover from the target cell by the terminal equipment 300 contained in the position information among the position information history.

Next, the determination unit 140 determines whether or not at least one of the time and distance acquired in step S401 falls below a predetermined threshold value (step S403). Here, when at least one of the time and distance falls below the predetermined threshold value, the determination unit 140 recognizes the cell specified by the cell ID contained in the record of the position information being the processing target as the candidate cell of the cell to which the terminal equipment 300 should not have been connected (step S405).

Subsequently, the determination unit 140 performs the determination process for each record described with reference to FIG. 14 against the position information record of the candidate cell (step S407).

On the other hand, when both of the time and distance do not fall below the predetermined value in step S403, the determination unit 140 ends the process here.

### Second Modified Example

Next, the second modified example will be described with reference to FIG. 21. FIG. 21 is a flowchart describing an example of process to be performed by the determination unit 140 to limit the records being the target for the determination process on each record to a record of a candidate cell satisfying predetermined conditions. The process is performed in step S205 of FIG. 13 as describe above. Here, in this example, it is assumed that information of an S/N ratio is contained in the position information acquired by the position information acquisition unit 120 and that a congestion factor of a cell may be acquired therefrom.

Referring to FIG. 21, the determination unit 140 firstly acquires the congestion factor of the cell specified by the cell ID contained in the record of the position information being the processing target (step S501). Here, as the congestion factor, a value of the S/N ratio contained in the position information may be utilized as-is or a value having a process such as normalization performed thereon may be utilized as well.

Next, the determination unit 140 determines whether or not the acquired congestion factor exceeds a predetermined value (step S503). Here, when the congestion factor exceeds the predetermined value, the determination unit 140 recognizes the cell specified by the cell ID contained in the record of the position information being the processing target as the candidate cell of the cell to which the terminal equipment 300 should not have been connected (step S505).

Subsequently, the determination unit 140 performs the determination process for each record described with reference to FIG. 14 against the position information record of the candidate cell (step S507).

On the other hand, when the acquired congestion factor does not exceed the predetermined value in step S503, the determination unit 140 ends the process here.

As the two modified examples described above, the determination unit 140 performs the determination process for each record accompanied by estimation rate calculating and the like only on the cells satisfying the predetermined conditions, so that time necessary for the process may be shortened.

### 2-6. Summary

In the above, the wireless communication system 10, the communication control apparatus 100, the base station 200, the terminal equipment 300 and the modified examples of the communication control apparatus 100 according to the present embodiment are described in detail with reference to FIGS. 4 to 21. With the communication control apparatus 100 according to the present embodiment, connection order of cells to be recommended may be acquired as removing cells to which the terminal equipment should not be connected from access points of the terminal equipment 300 based on the position information history of the terminal equipment 300. The determination of the cells to which the terminal equipment 300 should not be connected is performed by estimating the rate in the case that the terminal equipment 300 is connected to another cell. For example, the rate estimation is performed on the cells right before and after a certain cell to which the terminal equipment 300 has been connected. Further, the connection order of cells appropriate for the terminal equipment 300 is provided as forecasting a movement destination of the terminal equipment 300 based on the position information history. By performing the forecasting with the position information history also including position information history provided by other terminal equipment, the forecast accuracy may be increased. With the above configuration, it is possible to optimize order of switching cells to which terminal equipment is to be connected with handover.

Further, with the terminal equipment 300 according to the present embodiment, the handover performed by the terminal equipment 300 is controlled to be performed in accordance with the recommended cell connection order without specifically applying any modification on the base station 200. For example, by transmitting a measurement report of which measurement values are varied based on the recommended handover order data to the base station 200, the determination performed by the base station 200 whether or not the terminal equipment 300 should perform handover may be indirectly controlled. When a negative offset is added to the measurement value of the cell which is not contained in the recommended connection order as the variation of the measurement value, for example, it is possible to relatively lessen the measurement values of cells other than the cells contained in the recommended connection order.

Further, with the modified examples of the communication control apparatus 100 according to the present embodiment, time necessary for the process may be shortened by limiting cells of which rate calculation is performed corresponding to the time and distance based on the position information history. Further, when a congestion factor may be acquired from the position information history, time necessary for the process may be shortened by limiting cells of which rate calculation is performed based on the congestion factor.

It should be understood by those skilled in the art that various modifications, combinations, sub-combinations and alterations may occur depending on design requirements and other factors insofar as they are within the scope of the appended claims or the equivalents thereof.

For example, in the modified examples of the above embodiment, candidate cells to be candidates of cells to which terminal equipment should not have been connected are limited corresponding to the time, distance or congestion factor contained in the position information history and determination is performed on the candidate cells whether or not the terminal equipment should have been connected thereto as further calculating estimation rates of the cells of the before and the after. However, the present invention is not limited to such examples. For example, it is also possible that the candidate cells are directly determined as the cells to which the terminal equipment should not have been connected.

Further, in the above embodiment, the recommended handover order data is to be stored as being associated with hours. However, the present invention is not limited to such an example. For example, the recommended handover order data may be stored as being associated with a congestion factor of a cell.

Further, in the above embodiment, the recommended handover order data generated by a communication control apparatus is provided to terminal equipment. However, the present invention is not limited to such an example. For example, the recommended handover order data may be provided to a base station. In this case, the base station may be controlled not to determine that the terminal equipment should perform handover to the cell specified by a cell ID which is not contained in the recommended handover order data.

The present application contains subject matter related to that disclosed in Japanese Priority Patent Application JP 2010-082336 filed in the Japan Patent Office on Mar. 31, 2010, the entire content of which is hereby incorporated by reference.

What is claimed is:

1. A communication control apparatus to control handover with terminal equipment comprising:
a position information acquisition unit to acquire position information containing a position of the terminal equipment and a cell ID specifying a cell to which the terminal equipment is connected at the position;
a storage unit to store a series of the position information acquired by the position information acquisition unit as position information history;
a determination unit to determine whether or not the terminal equipment should have been connected to each cell specified by each cell ID contained in the position information history on a movement route of the terminal equipment corresponding to the position information history stored in the storage unit; and
a data generation unit to generate recommended handover order data indicating connection order of cells to be recommended for the terminal equipment by removing a cell ID specifying a cell determined to which the terminal equipment should not have been connected by the determination unit from the position information history.

2. The communication control apparatus according to claim 1,
wherein the storage unit further stores cell information to calculate an estimation rate at an arbitrary position of each cell constituting a wireless communication system; and
the determination unit determines a cell to which the terminal equipment should not have been connected by evaluating the estimation rate on the movement route of each cell specified by each cell ID contained in the position information history by utilizing the cell information stored in the storage unit.

3. The communication control apparatus according to claim 2,
wherein the determination unit calculates the estimation rates of two cells to which the terminal equipment has been connected respectively right before and right after being connected to a target cell at least at one position where the terminal equipment has been connected to the target cell specified by one of cell IDs contained in the position information history; and
the determination unit determines that the terminal equipment should not have been connected to the target cell when at least one of the estimation rates of the two cells exceeds a predetermined threshold value.

4. The communication control apparatus according to claim 1,
wherein the determination unit sets a cell having time or distance of connection with the terminal equipment satisfy a predetermined condition as a candidate cell among respective cells specified by respective cell IDs contained in the position information history; and
the determination unit determines whether or not the terminal equipment should have been connected thereto only for the candidate cell.

5. The communication control apparatus according to claim 4,
wherein the determination unit sets a cell having at least one of time and distance of connection with the terminal equipment fall below a predetermined threshold value as the candidate cell among respective cells specified by respective IDs contained in the position information history.

6. The communication control apparatus according to claim 1,
wherein the position information acquisition unit further acquires information indicating a congestion factor of each cell specified by each cell ID contained in the position information history;
the determination unit sets a cell having the congestion factor exceed a predetermined level as a candidate cell among respective cells specified by respective cell IDs contained in the position information history; and
the determination unit determines whether or not the terminal equipment should have been connected thereto only for the candidate cell.

7. The communication control apparatus according to claim 1, further comprising:
a forecast unit to forecast a movement destination of a moving terminal equipment by utilizing a position provided from the moving terminal equipment and the position information history; and
a data provision unit to provide the recommended handover order data to be selected based on the movement destination among one or more of the recommended handover order data to the moving terminal equipment.

8. The communication control apparatus according to claim 7,
wherein the position information history utilized by the forecast unit includes the position information history of terminal equipment other than the moving terminal equipment.

9. A communication control method to control handover with terminal equipment, comprising the steps of:
acquiring position information containing a position of the terminal equipment and a cell ID specifying a cell to which the terminal equipment is connected at the position;
storing a series of the position information in a storage device as position information history;
determining whether or not the terminal equipment should have been connected to each cell specified by each cell ID contained in the position information history on a movement route of the terminal equipment corresponding to the position information history; and
generating recommended handover order data indicating connection order of cells to be recommended for the terminal equipment by removing a cell ID specifying a cell determined to which the terminal equipment should not have been connected from the position information history.

10. A program for causing a computer to function as:
a mean to acquire position information containing a position of terminal equipment and a cell ID specifying a cell to which the terminal equipment is connected at the position;
a mean to store a series of the position information as position information history;
a mean to determine whether or not the terminal equipment should have been connected to each cell specified by each cell ID contained in the position information history on a movement route of the terminal equipment corresponding to the position information history; and
a mean to generate recommended handover order data indicating connection order of cells to be recommended for the terminal equipment by removing a cell ID specifying a cell determined to which the terminal equipment should not have been connected from the position information history.

11. A terminal equipment, comprising:
a wireless communication unit to perform wireless communication;
a position information provision unit to provide position information containing a position of the terminal equipment and a cell ID specifying a cell to which the terminal equipment is connected at the position to a communication control apparatus;
a data acquisition unit to acquire recommended handover order data from the communication control apparatus indicating connection order of cells to be recommended for the terminal equipment generated by removing a cell ID satisfying a predetermined condition from a series of the position information; and
a control unit to control wireless communication with the wireless communication unit so that a series of handover to be performed by the terminal equipment is performed in accordance with the connection order.

12. The terminal equipment according to claim 11,
wherein the control unit varies a measurement value of each cell contained in a measurement report to be transmitted to a base station in accordance with whether or not a cell ID specifying the cell is contained in the recommended handover order data.

13. The terminal equipment according to claim 12,
wherein the control unit adds a negative offset to a measurement value of the cell specified by the cell ID which is not contained in the recommended handover order data among measurement values of respective cells contained in the measurement report.

14. A wireless communication system comprising:
a communication control apparatus to control handover with terminal equipment; and
a terminal equipment;
wherein the communication control apparatus includes,
a position information acquisition unit to acquire position information containing a position of the terminal equipment and a cell ID specifying a cell to which the terminal equipment is connected at the position,
a storage unit to store a series of the position information acquired by the position information acquisition unit as position information history,
a determination unit to determine whether or not the terminal equipment should have been connected to each cell specified by each cell ID contained in the position information history on a movement route of the terminal equipment corresponding to the position information history stored in the storage unit, and
a data generation unit to generate recommended handover order data indicating connection order of cells to be recommended for the terminal equipment by removing a cell ID specifying a cell determined to which the terminal equipment should not have been connected by the determination unit from the position information history; and
the terminal equipment includes,
a wireless communication unit to perform wireless communication,
a position information provision unit to provide position information containing a position of the terminal equipment and a cell ID specifying a cell to which the terminal equipment is connected at the position to a communication control apparatus,
a data acquisition unit to acquire recommended handover order data from the communication control apparatus indicating connection order of cells to be recommended for the terminal equipment generated by removing a cell ID satisfying a predetermined condition from a series of the position information, and
a control unit to control wireless communication with the wireless communication unit so that a series of handover to be performed by the terminal equipment is performed in accordance with the connection order.
